(19) United States
(12) Patent Application Publication
(10) Pub. No.: US 2026/0079749 A1
(43) Pub. Date: Mar. 19, 2026

(54) EVICTION OF SUBPROCESS PODS IN A SERVERLESS WORKFLOW

(71) Applicant: International Business Machines Corporation, Armonk, NY (US)

(72) Inventors: Jing Jing Wei, Beijing (CN); Yue Wang, Beijing (CN); Yi Fan Wu, Beijing (CN); Shu Jun Tang, Beijing (CN); Qi Han Zheng, Beijing (CN); Jia Lin Wang, Beijing (CN); Yang Kang, Beijing (CN)

(21) Appl. No.: 18/085,914

(22) Filed: Dec. 21, 2022

(51) Int. Cl. G06F 9/50

(52) U.S. Cl. CPC G06F 9/5027

(57) ABSTRACT

A computer-implemented method, system and computer program product for handling eviction of subprocess pods of a node. An indication to evict pods of a node in a container environment is received. Upon receiving such an indication, process information pertaining to the evicted pods is retrieved. In scenarios in which some of the evicted pods include subprocess pods, based on such processing information, those subprocess pods with a timeout that is less than a threshold value may be tagged for timeout handling. Such timeout handling involves selecting a number of subprocess pods to ensure that their parent process will successfully complete its assigned job. A schedule plan may then be generated for such selected subprocess pods, where the schedule plan updates the timeout for such subprocess pods to enable them to complete execution of their assigned tasks prior to their expiration time (timeout) even though they were evicted.

### TECHNICAL FIELD

The present disclosure relates generally to a serverless workflow for container orchestration systems, and more particularly to handling the eviction of subprocess pods of a virtualized operating system in a serverless workflow.

### BACKGROUND

Container orchestration systems (e.g., Kubernetes®) automate the deployment, management, scaling and networking of containers. A container refers to a standard unit of software that packages up code and all its dependencies so that the application runs quickly and reliably from one computing environment to another.

These containers may be run in “pods” by the container orchestration systems. A “pod” is a group of one or more containers, which may be deployed to a node. All the containers in the pod share an Internet Protocol (IP) address, inter-process communication (IPC), hostname and other resources. Furthermore, a pod represents a single instance of a running process (instance of a program) in the cluster (discussed below).

Such pods may reside in a node, referred to as a “worker node.” A worker node is used to run containerized applications and handle networking to ensure that traffic between applications across the cluster and from outside of the cluster can be properly facilitated. A “cluster,” as used herein, refers to a set of nodes (e.g., worker nodes) that run containerized applications (containerized applications package an application with its dependencies and necessary services).

In container environments, services may be managed and orchestrated on a cluster using a serverless workflow. The “serverless workflow,” as used herein, refers to an open-source and vendor-neutral specification that enables one to define declarative workflow models that orchestrate event-driven applications. The specification is a project hosted by the Cloud Native Computing Foundation (CNCF).

The pods of a node in the container orchestration system utilizing the serverless workflow may each be responsible for executing a process, including executing subprocesses of a process. As discussed above, a pod represents a single instance of a running process (instance of a program) in the cluster. Such a process may be assigned multiple tasks to be completed. Furthermore, such a process (“parent process”) may utilize multiple instances of a subprocess to complete a parent process task of the parent process. A “task,” as used herein, refers to a unit of execution or a unit of work. Each of these subprocess instances though may have an expiration time (“timeout”) to complete the execution of their assigned tasks. In some situations, the parent process task of the parent process is completed only when the majority of the subprocess instances complete execution of their assigned tasks. If a majority of the subprocess instances do not complete their processing of their assigned tasks prior to their expiration time (“timeout”), then the parent process will fail resulting in the failure of the serverless workflow. A pod representing a single instance of a running process in the cluster is referred to herein as a “process pod.” A pod representing a subprocess is referred to herein as a “subprocess pod.”

Pods of a node in a container orchestration system utilizing the serverless workflow may be evicted due to resource consumption (e.g., processor, memory) in the node reaching a threshold level thereby freeing up the resource. Furthermore, pods of a node in a container orchestration system utilizing the serverless workflow may also be evicted due to node upgrades.

When pods of a node in a container environment utilizing the serverless workflow are evicted, including subprocess pods, such evicted subprocess pods may not be initially selected to run on an available node. By the time such evicted subprocess pods are able to run on a node, such subprocess pods may no longer have time to process its assigned tasks thereby resulting in the failure of the parent process and the serverless workflow.

### SUMMARY

In one embodiment of the present disclosure, a computer-implemented method for handling an eviction of subprocess pods of a virtualized operating system comprises receiving, by a computing device, an indication to evict pods of a node. The method further comprises retrieving process information pertaining to the evicted pods. The method additionally comprises generating a schedule plan for selected subprocess pods of the evicted pods with a timeout that is less than a threshold value, where the schedule plan updates the timeout for the selected evicted subprocess pods of the evicted pods. Furthermore, the method comprises scheduling the selected subprocess pods to run on an available node according to the schedule plan.

In this manner, the failure of a serverless workflow utilized in a container environment is prevented by updating the expiration time (timeout) of selected evicted subprocess pods in a manner that enables them to complete execution of their assigned tasks prior to their expiration time so that their parent process will not fail thereby preventing the failure of the serverless workflow.

In another embodiment of the present disclosure, a computer program product for handling an eviction of subprocess pods of a virtualized operating system, where the computer program product comprises one or more computer readable storage mediums having program code embodied therewith, where the program code comprising programming instructions for receiving, by a computing device, an indication to evict pods of a node. The program code further comprises the programming instructions for retrieving process information pertaining to the evicted pods. The program code additionally comprises generating a schedule plan for selected subprocess pods of the evicted pods with a timeout that is less than a threshold value, where the schedule plan updates the timeout for the selected evicted subprocess pods of the evicted pods. Furthermore, the program code comprises scheduling the selected subprocess pods to run on an available node according to the schedule plan.

In this manner, the failure of a serverless workflow utilized in a container environment is prevented by updating the expiration time (timeout) of selected evicted subprocess pods in a manner that enables them to complete execution of their assigned tasks prior to their expiration time so that their parent process will not fail thereby preventing the failure of the serverless workflow.

In a further embodiment of the present disclosure, a system comprises a memory for storing a computer program for handling an eviction of subprocess pods of a virtualized operating system and a processor connected to the memory. The processor is configured to execute program instructions of the computer program comprising receiving an indication to evict pods of a node. The processor is further configured to execute the program instructions of the computer program comprising retrieving process information pertaining to the evicted pods. The processor is additionally configured to execute the program instructions of the computer program comprising generating a schedule plan for selected subprocess pods of the evicted pods with a timeout that is less than a threshold value, where the schedule plan updates the timeout for the selected evicted subprocess pods of the evicted pods. Furthermore, the processor is configured to execute the program instructions of the computer program comprising scheduling the selected subprocess pods to run on an available node according to the schedule plan.

In this manner, the failure of a serverless workflow utilized in a container environment is prevented by updating the expiration time (timeout) of selected evicted subprocess pods in a manner that enables them to complete execution of their assigned tasks prior to their expiration time so that their parent process will not fail thereby preventing the failure of the serverless workflow.

The foregoing has outlined rather generally the features and technical advantages of one or more embodiments of the present disclosure in order that the detailed description of the present disclosure that follows may be better understood. Additional features and advantages of the present disclosure will be described hereinafter which may form the subject of the claims of the present disclosure.

### BRIEF DESCRIPTION OF THE DRAWINGS

A better understanding of the present disclosure can be obtained when the following detailed description is considered in conjunction with the following drawings, in which:

FIG. 1 illustrates a communication system for practicing the principles of the present disclosure in accordance with an embodiment of the present disclosure;

FIG. 2 illustrates the architecture of the container orchestration system in accordance with an embodiment of the present disclosure;

FIGS. 3A-3C illustrate process information pertaining to the evicted pods in accordance with an embodiment of the present disclosure;

FIG. 4 illustrates a process execution status table which includes an indication as to whether a subprocess pod needs timeout handling in accordance with an embodiment of the present disclosure;

FIG. 5 illustrates the execution status of each of the subprocesses of the evicted subprocess pods tagged for timeout handling in accordance with an embodiment of the present disclosure;

FIG. 6 illustrates the process execution task table in accordance with an embodiment of the present disclosure;

FIG. 7 illustrates updating the timeout for the selected subprocess pods in the process execution status table in accordance with an embodiment of the present disclosure;

FIG. 8 illustrates updating the timeout of an additional subprocess pod after the completion of a subprocess pod in accordance with an embodiment of the present disclosure;

FIG. 9 illustrates the process execution status table after completion of the originally selected evicted subprocess pods that were required to be completed in order to successfully complete the parent process task in accordance with an embodiment of the present disclosure;

FIG. 10 illustrates an embodiment of the present disclosure of the hardware configuration of the container orchestration system which is representative of a hardware environment for practicing the present disclosure;

FIG. 11 is a flowchart of a method for identifying evicted subprocess pods with a timeout that is less than a threshold value in accordance with an embodiment of the present disclosure;

FIG. 12 is a flowchart of a method for handling the eviction of the subprocess pods in a serverless workflow in accordance with an embodiment of the present disclosure;

FIG. 13 is a flowchart of a method for selecting particular evicted subprocess pods to run on an available node in accordance with an embodiment of the present disclosure; and

FIG. 14 is a flowchart of a method for handling the scheduling of an additional evicted subprocess pod after the completion of an evicted subprocess pod previously selected to run on an available node in accordance with an embodiment of the present disclosure.

### DETAILED DESCRIPTION

As stated in the Background section, in container environments, such as a container orchestration system, services may be managed and orchestrated on a cluster using a serverless workflow. The “serverless workflow,” as used herein, refers to an open-source and vendor-neutral specification that enables one to define declarative workflow models that orchestrate event-driven applications. The specification is a project hosted by the Cloud Native Computing Foundation (CNCF).

The pods of a node in the container orchestration system utilizing the serverless workflow may each be responsible for executing a process, including executing subprocesses of a process. As discussed above, a pod represents a single instance of a running process (instance of a program) in the cluster. Such a process may be assigned multiple tasks to be completed. Furthermore, such a process (“parent process”) may utilize multiple instances of a subprocess to complete a parent process task of the parent process. A “task,” as used herein, refers to a unit of execution or a unit of work. Each of these subprocess instances though may have an expiration time (“timeout”) to complete the execution of their assigned tasks. In some situations, the parent process task of the parent process is completed only when the majority of the subprocess instances complete execution of their assigned tasks. If a majority of the subprocess instances do not complete their processing of their assigned tasks prior to their expiration time (“timeout”), then the parent process will fail resulting in the failure of the serverless workflow. A pod representing a single instance of a running process in the cluster is referred to herein as a “process pod.” A pod representing a subprocess is referred to herein as a “subprocess pod.”

Pods of a node in a container orchestration system utilizing the serverless workflow may be evicted due to resource consumption (e.g., processor, memory) in the node reaching a threshold level thereby freeing up the resource. Furthermore, pods of a node in a container orchestration system utilizing the serverless workflow may also be evicted due to node upgrades.

When pods of a node in a container environment utilizing the serverless workflow are evicted, including subprocess pods, such evicted subprocess pods may not be initially selected to run on an available node. By the time such evicted subprocess pods are able to run on a node, such subprocess pods may no longer have time to process its assigned tasks thereby resulting in the failure of the parent process and the serverless workflow.

The embodiments of the present disclosure provide a means for preventing the failure of a serverless workflow being utilized in a container environment by updating the timeout of selected evicted subprocess pods in a manner that enables them to complete execution of their assigned tasks prior to their expiration time (timeout) so that their parent process will not fail thereby preventing the failure of the serverless workflow as discussed further below.

In some embodiments of the present disclosure, the present disclosure comprises a computer-implemented method, system and computer program product for handling eviction of subprocess pods of a node. In one embodiment of the present disclosure, an indication to evict pods of a node in a container environment is received. Such eviction may result due to resource consumption (e.g., processor, memory) in the node reaching a threshold level or due to node upgrades. Upon receiving such an indication, process information pertaining to the evicted pods is retrieved. “Process information,” as used herein, refers to information pertaining to the serverless workflow being processed by the pods. Such process information includes information pertaining to whether a process has a subprocess, the start time for processing tasks, the expiration time (timeout) for processing such tasks, if applicable, the parent process and the parent process task, if applicable, etc. In scenarios in which some of the evicted pods include subprocess pods, based on such processing information, those subprocess pods with a timeout (expiration time for processing their assigned tasks) that is less than a threshold value may be tagged for timeout handling. Such timeout handling involves identifying the number of subprocess pods that need to be selected in order to ensure that their parent process will successfully complete its assigned job. Furthermore, such timeout handling involves selecting such a number of subprocess pods based on their execution status being most complete of their assigned tasks. A schedule plan may then be generated for such selected subprocess pods, where the schedule plan updates the timeout for such subprocess pods to enable them to complete execution of their assigned tasks prior to their expiration time (timeout) even though they were evicted. Such selected subprocess pods may then be scheduled to run on an available node according to the schedule plan. In this manner, by ensuring that such subprocess pods complete execution of their assigned tasks prior to their expiration time (timeout), their parent process will not fail thereby preventing the failure of the serverless workflow.

In the following description, numerous specific details are set forth to provide a thorough understanding of the present disclosure. However, it will be apparent to those skilled in the art that the present disclosure may be practiced without such specific details. In other instances, well-known circuits have been shown in block diagram form in order not to obscure the present disclosure in unnecessary detail. For the most part, details considering timing considerations and the like have been omitted inasmuch as such details are not necessary to obtain a complete understanding of the present disclosure and are within the skills of persons of ordinary skill in the relevant art.

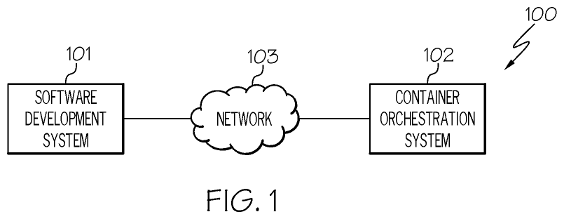

Referring now to the Figures in detail, FIG. 1 illustrates an embodiment of the present disclosure of a communication system 100 for practicing the principles of the present disclosure. Communication system 100 includes a software development system 101 connected to a container orchestration system 102 via a network 103.

Software development system 101 is a system utilized, such as by software developers, in the process of creating, designing, deploying, and supporting software. Examples of such software development systems include, but not limited to, RAD Studio®, embold®, Collaborator®, Studio 3T®, NetBeans®, Zend Studio®, Microsoft® Expression Studio, etc.

In one embodiment, software development system 101 is utilized by a software developer to deploy, manage, scale and network containers using container orchestration system 102 (e.g., Kubernetes®, Apache® Mesos, Amazon ECS®) via network 103.

Network 103 may be, for example, a local area network, a wide area network, a wireless wide area network, a circuit-switched telephone network, a Global System for Mobile Communications (GSM) network, a Wireless Application Protocol (WAP) network, a WiFi network, an IEEE 802.11 standards network, various combinations thereof, etc. Other networks, whose descriptions are omitted here for brevity, may also be used in conjunction with system 100 of FIG. 1 without departing from the scope of the present disclosure.

In one embodiment, container orchestration system 102 automates the deployment, management, scaling, and networking of containers. A “container,” as used herein, refers to a standard unit of software that packages up code and all its dependencies so that the application runs quickly and reliably from one computing environment to another.

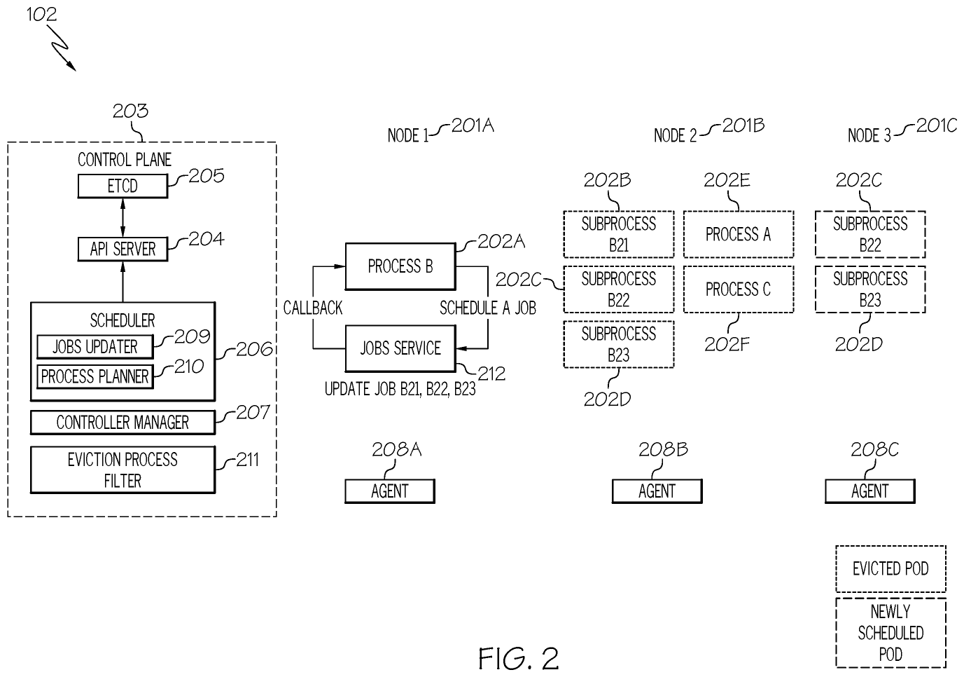

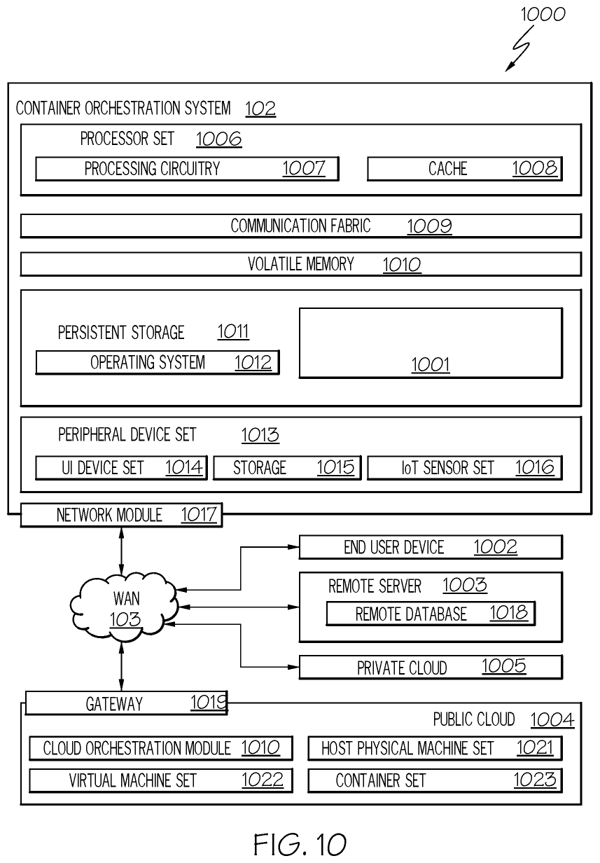

Furthermore, in one embodiment, container orchestration system 102 is configured to prevent the failure of a serverless workflow being utilized in a container environment by updating the timeout for selected evicted subprocess pods in a manner that enables them to complete execution of their assigned tasks prior to their expiration time (timeout) as discussed further below. A description of the architecture of container orchestration system 102 is provided below in connection with FIG. 2. A description of the hardware configuration of container orchestration system 102 is provided further below in connection with FIG. 10.

System 100 is not to be limited in scope to any one particular network architecture. System 100 may include any number of software development systems 101, container orchestration systems 102 and networks 103.

Referring now to FIG. 2, in conjunction with FIG. 1, FIG. 2 illustrates the architecture of container orchestration system 102 in accordance with an embodiment of the present disclosure.

As shown in FIG. 2, container orchestration system 102 includes a cluster consisting of a set of worker machines, referred to herein as nodes 201A-201C (identified as “Node 1,” “Node 2,” and “Node 3,” respectively in FIG. 2), that run containerized applications. Nodes 201A-201C may collectively or individually be referred to as nodes 201 or node 201, respectively. While FIG. 2 illustrates three nodes 201, a cluster of container orchestration system 102 may include any number of nodes 201.

In one embodiment, nodes 201 host the pods that are the components of the application workload. For example, as shown in FIG. 2, node 201A hosts pod 202A (identified as “Process B” in FIG. 2). Node 201B hosts pods 202B-202F (identified as “Subprocess B21,” “Subprocess B22,” “Subprocess B23,” “Process A,” and “Process C,” respectively, in FIG. 2). As will be discussed in greater detail below, pods 202B-202F are “evicted pods” in that such pods 202, both process and subprocess pods, in container orchestration system 102 utilizing the serverless workflow are evicted. For example, such pods 202B-202F may be evicted due to resource consumption in node 201B reaching a threshold level thereby freeing up the resource or may be evicted due to an upgrade of node 201B. Pods 202A-202F may collectively or individually be referred to as pods 202 or pod 202, respectively. Furthermore, as shown in FIG. 2, node 201C has availability to host other pods, such as two of the evicted pods (e.g., pods 202B-202F), which in the illustrative embodiment of FIG. 2 corresponds to subprocess pods 202C and 202D as discussed in further detail below.

Furthermore, as shown in FIG. 2, container orchestration system 102 includes a control plane 203 configured to manage nodes 201 and pods 202 in the cluster. In one embodiment, in production environments, control plane 203 runs across multiple computers providing fault-tolerance and high availability. Furthermore, in one embodiment, control plane 203 coordinates the behavior of proxies and provides APIs for operations and maintenance.

In one embodiment, the components of control plane 203 make global decisions about the cluster (for example, scheduling) as well as detecting and responding to cluster events (for example, starting up a new pod 202 when a deployment's replicas field is unsatisfied).

In one embodiment, the components of control plane 203 can be run on any machine in the cluster.

In one embodiment, control plane 203 includes an API (application programming interface) server 204 (e.g., kube-apiserver). In one embodiment, API server 204 is configured to scale horizontally, i.e., it scales by deploying more instances. In one embodiment, several instances of API server 204 may be run and traffic may be balanced between those instances.

Furthermore, in one embodiment, control plane 203 includes etcd 205. Etcd 205, as used herein, corresponds to a distributed key-value store that provides a way to store data that needs to be accessed by a distributed system or cluster of machines. In one embodiment, etcd 205 is utilized for storing all the cluster data.

Additionally, in one embodiment, control plane 203 includes a scheduler 206 (e.g., kube-scheduler) that selects a node 201 for newly created pods 202 to run on. In one embodiment, scheduler 206 utilizes various factors for scheduling decisions, such as individual and collective resource requirements, hardware/software/policy constraints, affinity and anti-affinity specifications, data locality, inter-workload interference, and deadlines.

Furthermore, in one embodiment, control plane 203 includes a controller manager 207 (e.g., kube-controller-manager) configured to run controller processes. In one embodiment, controller manager 207 manages various controllers. “Controllers,” as used herein, refer to control loops that continuously watch the state of the cluster and then make or request changes where needed. In one embodiment, each controller tries to move the current cluster state closer to the desired state. There are various types of controllers including, node controllers (responsible for noticing and responding when nodes 201 go down), job controllers (watch for job objects that represent one-off tasks and then create pods 202 to run those tasks to completion), end controllers (populate the endpoint objects, such as joining the services and pods 202), and service account and token controllers (create default accounts and API access tokens for new namespaces).

Additionally, in one embodiment, container orchestration system 102 includes an agent 208A-208C (e.g., kubelet) that runs on each node 201A-201C, respectively, of the cluster. Agents 208A-208C may collectively or individually be referred to as agents 208 or agent 208, respectively. In one embodiment, agent 208 ensures that the containers are running in a pod 202. In one embodiment, agent 208 ensures that the containers described in a file or specification, commonly referred to as a “podspec,” which describes a version of the pod library, are running and healthy. In one embodiment, agent 208 (e.g., agent 208B) is responsible for evicting pods 202 (e.g., pods 202B-202F) in its associated node (e.g., node 201B) in response to receiving an instruction to evict such pods 202 from scheduler 206. As discussed above, scheduler 206 determines to evict pods 202 (e.g., pods 202B-202F) in response to a resource consumption (e.g., processor, memory) in node 201 (e.g., node 201B) reaching a threshold level or in response to node 201 (e.g., node 201B) being upgraded.

Furthermore, as shown in FIG. 2, scheduler 206 includes a jobs updater 209 and a process planner 210. Furthermore, as shown in FIG. 2, control plane 203 further includes an eviction process filter 211.

In one embodiment, eviction process filter 211 retrieves process information pertaining to the evicted pods, such as pods 202B-202F, running on a node 201, such as node 201B. Furthermore, in one embodiment, eviction process filter 211 checks if the evicted pods, such as pods 202B-202F, have a timeout less than a threshold value, and if so, tags them as needing timeout handling. “Timeout,” as used herein, refers to the time (expiration time) that pod 202 ceases to perform processing of the tasks. A further discussion regarding these and other features is provided below.

In one embodiment, process planner 210 constantly generates a schedule plan for the evicted pods, such as pods 202B-202F. A “schedule plan,” as used herein, refers to the placement and eviction of pods 202 on nodes 201. For example, the schedule plan may include the placement of an evicted pod, such as pod 202D, on an available node 201 (e.g., node 201C) with available resources to run the evicted pod. Furthermore, the schedule plan may also include the eviction of a pod 202 running on a node 201, such as a previously evicted pod (e.g., pod 202D) that has completed its processing of its assigned tasks on that node 201 (e.g., node 201C), thereby freeing that node 201 (e.g., node 201C) to host another pod 202, such as a previously evicted pod (e.g., pod 202B). A further discussion regarding these and other features is provided below.

In one embodiment, jobs updater 209 updates the job timeout by communicating with jobs service 212. “Job timeout,” as used herein, refers to the maximum period of time for a job to complete. A “job,” as used herein, is a unit of work or unit of execution (that performs the work). In one embodiment, jobs service 212 is configured to receive an instruction to schedule a job from a parent process, such as process B of pod 202A, to its subprocesses, such as subprocess B21 of pod 202B, subprocess B22 of pod 202C and subprocess B23 of pod 202D. That is, jobs service 212 updates the jobs or tasks to be assigned to such subprocesses. Upon completion of scheduling the requested job, jobs service 212 informs the requesting process pod 202, such as pod 202A, regarding the completion of scheduling the requested job via a callback.

Referring to FIG. 2, pods 202 running on nodes 201 may be executing process A, process B and Process C. A “process,” as used herein, refers to an instance of a program. For instance, process A is executed on pod 202E, process B is executed on pod 202A, and process C is executed on pod 202F. Such a process may include multiple tasks to be completed. A “task,” as used herein, refers to a unit of execution or a unit of work. For example, process B may have three tasks, B1, B2 and B3. To complete a task, multiple instances of a subprocess may be implemented in order to complete the task. For example, task B2 may require multiple instances of a subprocess (e.g., subprocess B21 executed on pod 202B, subprocess B22 executed on pod 202C and subprocess B23 executed on pod 202D) to be executed in order to complete the task. A pod representing a single instance of a running process in the cluster is referred to herein as a “process pod,” such as pods 202A, 202E and 202F. A pod representing a subprocess is referred to herein as a “subprocess pod,”such as pods 202B-202D.

In one embodiment, each subprocess instance has an expiration time (“timeout”). In certain situations, only when the majority of the subprocess instances (such as subprocesses B21, B22 and B23 executed on subprocess pods 202B-202D, respectively) complete execution of their assigned tasks does the parent process (e.g., such as process B executed on pod 202A) complete its assigned job. If a majority of the subprocess instances do not complete their processing of their assigned tasks prior to their expiration time (“timeout”), then the parent process will fail resulting in the failure of the serverless workflow.

The embodiments of the present disclosure provide a means for preventing the failure of a serverless workflow being utilized in a container environment by updating the timeout for selected evicted subprocess pods, such as subprocess pods 202C, 202D, in a manner that enables them to complete execution of their assigned tasks prior to their expiration time (timeout) as discussed below.

In one embodiment, eviction process filter 211 retrieves process information pertaining to evicted pods 202 running on a node 201 (e.g., node 201B) in response to receiving an indication to evict pods 202 running on node 201 (e.g., node 201B). In one embodiment, such an indication may be provided to eviction process filter 211 from agent 208, such as in response to receiving an indication to evict pods 202 (e.g., pods 202B-202F) in its associated node (e.g., node 201B) from scheduler 206 which determined to evict such pods 202 in response to the resource consumption (e.g., processor, memory) in node 201 (e.g., node 201B) reaching a threshold level or in response to node 201 (e.g., node 201B) being upgraded.

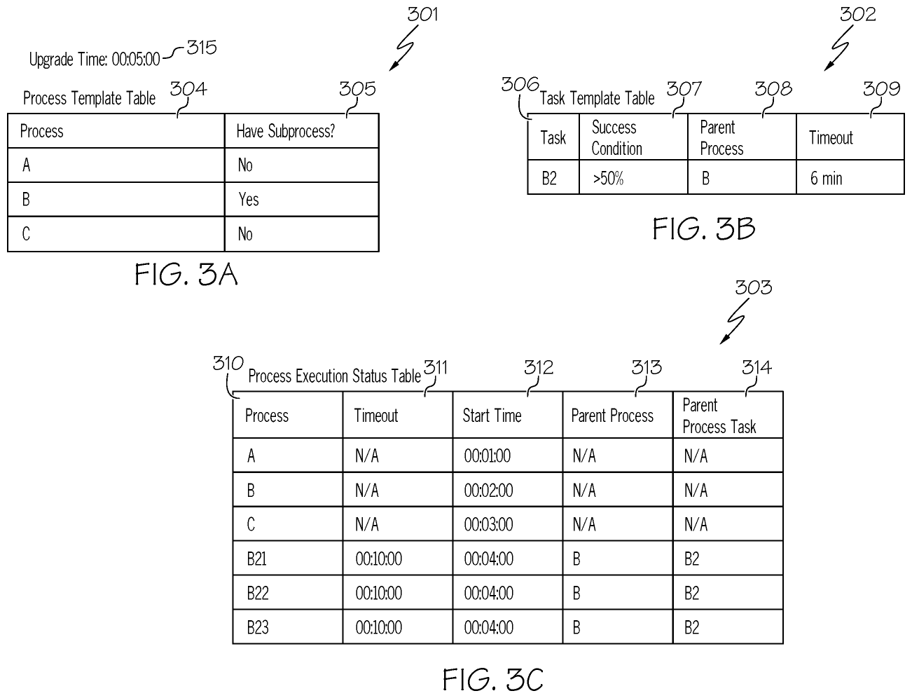

“Process information,” as used herein, refers to information pertaining to the serverless workflow being processed by pods 202. An illustration of such process information is provided in connection with FIGS. 3A-3C.

Referring to FIGS. 3A-3C, FIGS. 3A-3C illustrate process information pertaining to the evicted pods in accordance with an embodiment of the present disclosure.

As shown in FIGS. 3A-3C, such process information may be stored in tables, such as table 301 (process template table), table 302 (task template table) and table 303 (process execution status table). In one embodiment, such tables 301, 302, 303 are stored in a storage device (e.g., disk unit, memory) of container orchestration system 102.

In one embodiment, as shown in FIG. 3A, process template table 301 includes a column 304 listing the processes (e.g., process A, B and C) and a column 305 that indicates whether such a process includes a subprocess. As shown in table 301, process B includes a subprocess.

Furthermore, as shown in FIG. 3B, task template table 302 indicates a column 306 designating the task, such as task B2, and a column 307 that indicates its success condition. A “success condition,” as used herein, refers to the percentage of subprocesses that need to complete execution of its assigned tasks prior to having such a task, task B2, complete. As shown in table 302, the success condition for task B2 is >50%. As a result, if task B2 involved three subprocesses, such as subprocess B21 executed on pod 202B, subprocess B22 executed on pod 202C and subprocess B23 executed on pod 202D, then two out of the three subprocesses would need to complete execution of their assigned tasks in order to meet the success condition of greater than 50% (2 out of 3 is greater than 50%).

Furthermore, as shown in FIG. 3B, task template table 302 includes a column 308 regarding the parent process. For example, for task B2, the parent process is process B. Also, as shown in FIG. 3B, task template table 302 includes a column 309 regarding the “timeout.” A “timeout,” as used herein, refers to the time (expiration time) that pod 202 ceases to perform processing of the tasks. In the example of FIG. 3B, the timeout is 6 minutes for each of the subprocess pods 202B-202D used to execute its subprocesses.

Additionally, as shown in FIG. 3C, process execution status table 303 includes a column 310 regarding the process as well as a column 311 indicating whether such a process, including a subprocess, includes a timeout, and if so, the expiration time that pod 202 ceases to perform processing of its assigned tasks.

Furthermore, as shown in FIG. 3C, process execution status table 303 includes a column 312 that indicates the start time for performing the processing of its assigned tasks. For example, the start time (see column 312) for process A pod 202E to begin performing the processing of its assigned tasks is 00:01:00 (hours: minutes: seconds format). The expiration time (see column 313) for performing such processing for process A pod 202E is not applicable (N/A) since it is not a subprocess.

In another example, the start time for process B pod 202A to begin performing the processing of its assigned tasks is 00:02:00 (hours: minutes: seconds format). The expiration time for performing such processing for process B pod 202A is not applicable (N/A) since it is not a subprocess.

In a further example, the start time for process C pod 202F to begin performing the processing of its assigned tasks is 00:03:00 (hours: minutes: seconds format). The expiration time for performing such processing for process C pod 202F is not applicable (N/A) since it is not a subprocess.

In another example, the start time for subprocess B21 pod 202B to begin performing the processing of its assigned tasks is 00:04:00 (hours: minutes: seconds format). The expiration time for performing such processing for subprocess B21 pod 202B is 00:10:00, which corresponds to 6 minutes (timeout for task B2 as shown in column 309 of task template table 302) after the start time.

In a further example, the start time for subprocess B22 pod 202C to begin performing the processing of its assigned tasks is 00:04:00 (hours: minutes: seconds format). The expiration time for performing such processing for subprocess B22 pod 202C is 00:10:00, which corresponds to 6 minutes (timeout for task B2 as shown in column 309 of task template table 302) after the start time.

In another example, the start time for subprocess B23 pod 202D to begin performing the processing of its assigned tasks is 00:04:00 (hours: minutes: seconds format). The expiration time for performing such processing for subprocess B23 pod 202D is 00:10:00, which corresponds to 6 minutes (timeout for task B2 as shown in column 309 of task template table 302) after the start time.

Additionally, as shown in FIG. 3C, process execution status table 303 includes a column 313 directed to the parent process and a column 314 directed to the parent process task. As shown in FIG. 3C, subprocesses B21, B22 and B23 have a parent process of process B and a parent process task of B2. Furthermore, as shown in FIG. 3C, processes A, B and C do not have a parent process or a parent process task (identified as “N/A” for not applicable).

In one embodiment, such information is populated in tables 301, 302 and 303 by scheduler 206 and jobs service 212.

In one embodiment, upon retrieving the process information pertaining to the evicted pods 202, eviction process filter 211 is configured to determine if there is any subprocess pod 202 with a timeout, and if so, if the timeout is less than a threshold value.

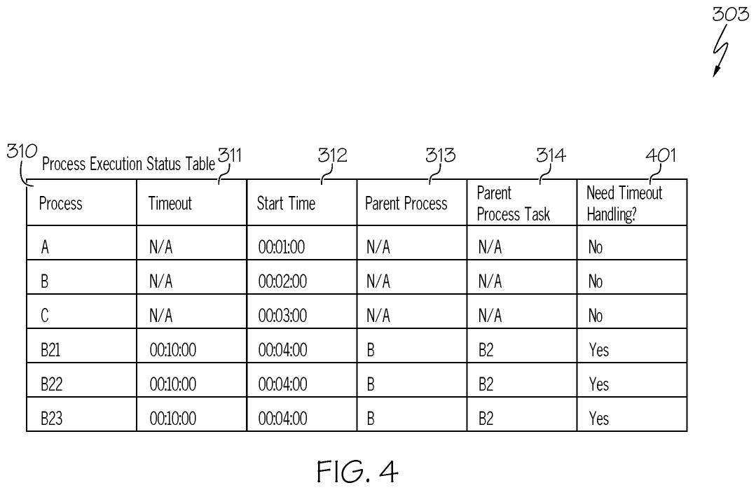

As shown in FIG. 3C, subprocess pods 202B, 202C and 202D have a timeout or expiration time corresponding to 00:10:00. In one embodiment, such a time out is compared with a threshold value. In one embodiment, in the situation in which pods 202 (e.g., pods 202B-202F) are evicted as a result of a node upgrade, the threshold value corresponds to the upgrade start time (start time to begin upgrade) plus the node upgrade average time (average time to perform upgrade of the node, such as node 201B). For example, as shown in FIG. 3A, the upgrade start time 315 is 00:05:00. If the node upgrade average time is 04:00:00, then the threshold value corresponds to 04:05:00. If the timeout (e.g., 00:10:00) is less than the threshold value (e.g., 04:05:00), then the subprocess pod 202 will not have enough time to complete execution of its assigned tasks. If less than a majority of the subprocess instances of the parent process complete execution of its assigned tasks prior to their expiration time (timeout), then the parent process will fail resulting in the failure of the serverless workflow. As a result, in such situations, eviction process filter 211 tags such a subprocess of the evicted pods (e.g., pods 202B-202D) for timeout handling, such as shown in FIG. 4. In one embodiment, the node upgrade average time is obtained from scheduler 206, which keeps track of the average upgrade time for upgrading node 201.

Referring to FIG. 4, FIG. 4 illustrates process execution status table 303 which includes an indication as to whether a subprocess pod needs timeout handling in accordance with an embodiment of the present disclosure.

As shown in FIG. 4, process execution status table 303 includes a column 401 indicating whether there is a need for timeout handling. Such information is provided by eviction process filter 211 as discussed above.

As shown in FIG. 4, subprocesses B21, B22 and B23 of the evicted subprocess pods 202B, 202C and 202D, respectively, need timeout handling. Such an indication is referred to herein as “tagging.”

In response to tagging such subprocesses, process planner 210 generates a schedule plan for such evicted pods (e.g., pods 202B-202D).

In one embodiment, process planner 210 selects one or more evicted subprocess pods 202 out of those subprocess pods (e.g., pods 202B-202D) tagged for timeout handling to be scheduled to run on an available node 201 (e.g., node 201C).

In one embodiment, process planner 210 identifies the number of subprocess pods 202 (e.g., subprocess pods 202B-202D) that need to be selected to run on an available node 201 (e.g., node 201C) in order to ensure that its parent process task (e.g., B2) will successfully complete its assigned job. As previously shown in FIG. 3B, task template table 302 indicates that the success condition for task B2 is greater than 50%. Since there are three subprocesses (subprocess B21, B22 and B23), at least two of these subprocesses need to be selected to complete execution of their tasks in order to ensure that the parent task process (task B2) is successfully completed by the parent process (process B).

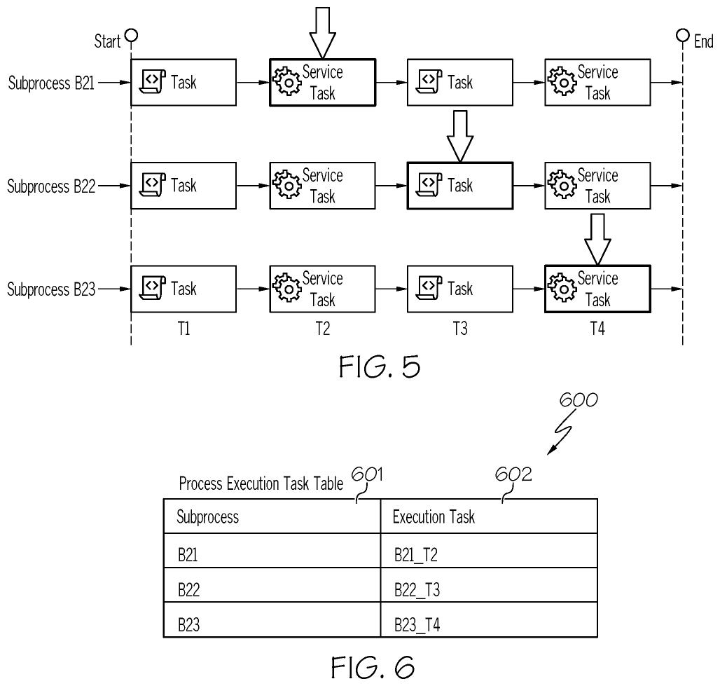

In one embodiment, the particular evicted subprocess pods 202 that are tagged for timeout handling that are selected to be run on an available node 201 (e.g., node 201C) is based on their execution status being most complete of their assigned tasks. As a result, in one embodiment, process planner 210 identifies the execution status of each evicted subprocess pod 202 (e.g., subprocess pods 202B-202D) tagged for timeout handling as shown in FIG. 5.

FIG. 5 illustrates the execution status of each of the subprocesses (e.g., subprocesses B21, B22 and B23) of the evicted subprocess pods (e.g., pods 202B-202D) tagged for timeout handling in accordance with an embodiment of the present disclosure.

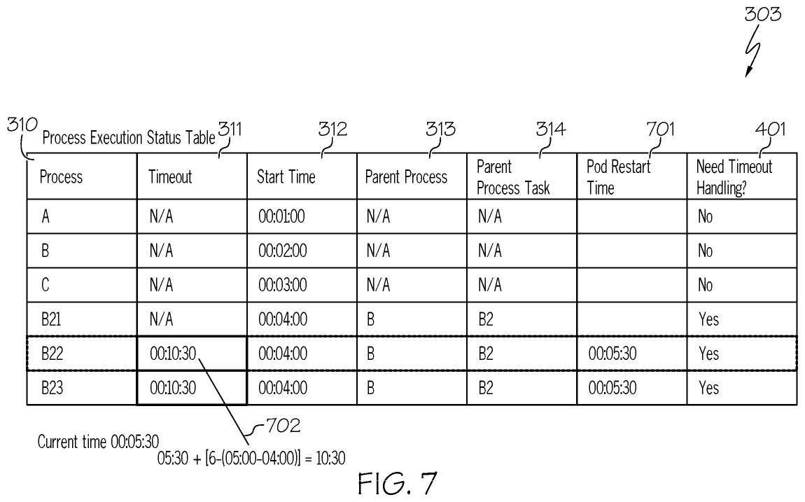

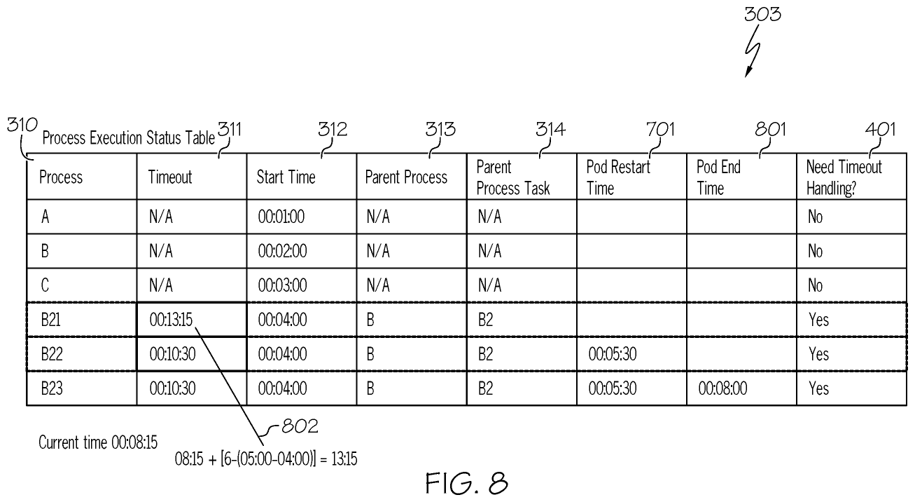

Referring to FIG. 5, subprocess B21 is currently processing a service task at time T2. Subprocess B22 is currently processing a task at time T3 and subprocess B23 is currently processing a service task at time T4. Such information as shown in FIG. 5 may be stored in a table, such as shown in FIG. 6.

FIG. 6 illustrates the process execution task table 600 in accordance with an embodiment of the present disclosure.

As shown in FIG. 6, process execution task table 600 includes a column 601 that stores an indication of the subprocess (e.g., subprocess B21, B22 and B23) as well as a column 602 that stores the execution task currently being performed by the corresponding subprocess. For example, for subprocess B21, it is currently processing a service task at time T2 as indicated by “B21_T2” in column 602. In another example, for subprocess B22, it is currently processing a task at time T3 as indicated by “B22_T3” in column 602. In a further example, for subprocess B23, it is currently processing a service task at time T4 as indicated by “B23_T4” in column 602.

In one embodiment, such information is populated in table 600 as shown in FIG. 5 by process planner 210 monitoring the current execution status of the assigned tasks by the subprocess pods 202. In one embodiment, process planner 210 monitors the current execution status of the subprocess pods 202 by monitoring the logs, such as the output generated by the subprocess pods 202. In one embodiment, such an output is generated by the containers of the subprocess pod 202, such as using the stdout and stderr data streams. In one embodiment, the output is accessed via the kubectl logs command. In one embodiment, process planner 210 uses various software tools to provide such monitoring, including, but not limited to, Datadog®, Kubelet, cAdvisor, Jaeger, Weave Scope, etc.

In one embodiment, based on the execution status of the evicted subprocess pods 202 tagged for timeout handling, process planner 210 selects the identified number of subprocess pods 202 (e.g., subprocess pods 202C, 202D) that need to be selected to run on an available node 201 (e.g., node 201C) in order to ensure that its parent process task (e.g., B2) will successfully complete its assigned job. For example, as discussed above, in order to ensure that the parent process task of B2 will successfully complete its assigned job, two out of the three subprocesses (B21, B22, B23) need to be selected. In one embodiment, process planner 210 selects those evicted subprocess pods 202 based on the their execution status being most complete of their assigned tasks to run on an available node 201 (e.g., node 201C), where the number of the selected subprocess pods 202 corresponds to the number of subprocess pods 202 that need to be selected to run on an available node 201 (e.g., node 201C) in order to ensure that its parent process task (e.g., B2) will successfully complete its assigned job. “Most complete,” as used herein, refers to being furthest along in completing the execution of their assigned tasks. As a result, referring to FIGS. 5 and 6, process planner 210 selects subprocess pods 202C and 202D, which are the two subprocess pods that are most complete of their assigned tasks. By selecting subprocess pods that are most complete of their assigned tasks, resource utilization is maximized. That is, by first scheduling subprocess instances with faster progress, resource utilization will be maximized. The scheduled placement of such evicted subprocess pods 202 (e.g., subprocess pods 202C and 202D) to run on the available node 201 (e.g., node 201C) corresponds to the schedule plan for such evicted subprocess pods 202 (e.g., subprocess pods 202C and 202D). By selecting those subprocess pods 202 (e.g., subprocess pods 202C and 202D) that are most complete of their assigned tasks, the likelihood of ensuring that its parent process task (e.g., B2) will successfully complete its assigned job is improved.

Furthermore, in order to ensure that its parent process task (e.g., B2) will successfully complete its assigned job thereby preventing the failure of the serverless workflow, the timeout for such selected subprocess pods 202 needs to be updated by jobs updater 209 as discussed below. In one embodiment, the schedule plan updates the timeout for the selected evicted subprocess pods 202 (e.g., subprocess pods 202C and 202D) by jobs updater 209. In one embodiment, jobs updater 209 updates the timeout for the selected evicted subprocess pods 202 (e.g., subprocess pods 202C and 202D) based on the current time and timeout for the parent process as discussed further below.

In one embodiment, in the scenario in which the subprocess pods 202 (e.g., subprocess pods 202C and 202D) are evicted due to an update to node 201 (e.g., node 201B), jobs updater 209 updates the timeout for the selected evicted subprocess pods 202 (e.g., subprocess pods 202C and 202D) by adding to the current time the (timeout for the parent process—(upgrade start time—start time for performing the processing of its assigned tasks)). In one embodiment, the timeout for the parent process may be identified from column 309 of task template table 302 of FIG. 3B. In one embodiment, the upgrade start time may be identified from element 315 of FIG. 3A. In one embodiment, the start time for performing the processing of its assigned tasks may be identified from column 312 of process execution status table 303 of FIG. 3C. In one embodiment, jobs updater 209 obtains such information to compute the updated timeout from the tables discussed above.

For example, if the current time is 00:05:30, the timeout for the parent process for subprocess pods 202C, 202D is 6 minutes (see column 309 of task template table 302 of FIG. 3B), the upgrade start time is 00:05:00 (see element 315 of FIG. 3A), and the start time for performing the processing of its assigned tasks is 00:04:00 (see column 312 of process execution status table 303 of FIG. 3C), then the updated timeout is 00:10:30 (00:05:30+(6 minutes−(00:05:00−00:04:00))) as shown in FIG. 7.

FIG. 7 illustrates updating the timeout for the selected subprocess pods 202 (e.g., subprocess pods 202C, 202D) in process execution status table 303 in accordance with an embodiment of the present disclosure.

Referring to FIG. 7, table 303 includes a column 701 for the pod restart time, which corresponds to the time (current time, such as 00:05:30) to restart the processing of the assigned tasks for those particular subprocesses (e.g., B22 and B23) by its subprocess pod 202 (e.g., subprocess pods 202C, 202D). Such a current time corresponds to the eviction time (30 seconds) plus the time at which eviction of pods 202 occurred. As shown in FIG. 7, the pod restart time for evicted subprocess pods 202C, 202D (for subprocesses B22, B23, respectively) is 00:05:30, which corresponds to the current time, as shown in column 701. Furthermore, as discussed above, the updated timeout corresponds to 00:10:30 as shown by element 702 when the current time is 00:05:30, the timeout for the parent process for subprocess pods 202C, 202D is 6 minutes (see column 309 of task template table 302 of FIG. 3B), the upgrade start time is 00:05:00 (see element 315 of FIG. 3A), and the start time for performing the processing of its assigned tasks is 00:04:00 (see column 312 of process execution status table 303 of FIG. 3C). Such an updated timeout is reflected in column 311 of process execution status table 303 as shown in FIG. 7.

In one embodiment, after generating the schedule plan for the selected evicted subprocess pods 202 to run on an available node 201, such as node 201C, where the schedule plan updates the timeout for the selected evicted subprocess pods 202 (e.g., subprocess pods 202C, 202D), scheduler 206 schedules the selected subprocess pods 202 (e.g., subprocess pods 202C, 202D) to run on an available node 201 (e.g., node 201C) according to the schedule plan. Furthermore, in one embodiment, jobs updater 209 informs jobs service 212 regarding the updated timeout of the selected evicted subprocess pods 202 (e.g., subprocess pods 202C, 202D). In one embodiment, jobs service 212 instructs scheduler 206 to proceed with scheduling the selected evicted subprocess pods 202 to run on the available node 201 (e.g., node 201C) and to instruct the selected evicted subprocess pods 202 (e.g., subprocess pods 202C, 202D) to start processing its assigned tasks at 00:05:30.

In one embodiment, process planner 210 monitors the current execution status of the subprocess pods 202 (e.g., subprocess pods 202C, 202D) that were started on the available node 201 (e.g., node 201C) by monitoring the logs, such as the output generated by the subprocess pods 202 (e.g., subprocess pods 202C, 202D). In one embodiment, such an output is generated by the containers of the subprocess pod 202, such as using the stdout and stderr data streams. In one embodiment, the output is accessed via the kubectl logs command. In one embodiment, process planner 210 uses various software tools to provide such monitoring, including, but not limited to, Datadog®, Kubelet, cAdvisor, Jaeger, Weave Scope, etc.

If one of the subprocess pods 202 (e.g., subprocess pod 202D) has completed executing its assigned tasks, such as for subprocess B23, then process planner 210 informs scheduler 206 regarding the completion of executing its assigned tasks by subprocess pod 202 (e.g., subprocess pod 202D). In one embodiment, scheduler 206 then instructs the appropriate agent 208 (e.g., agent 208C) to evict such a subprocess pod 202D from node 201 (e.g., node 201C).

In one embodiment, if there are additional evicted subprocess pods 202 (e.g., subprocess pod 202B) that have not yet been restarted to process its assigned tasks prior to the completion of the parent process task (e.g., B2), then process planner 210 selects an evicted subprocess pod 202 (e.g., subprocess pod 202B) out of the evicted subprocess pods 202 with the same parent process task (e.g., B2) that has not yet been restarted based on the execution status being most complete of its assigned tasks. In the scenario illustrated in FIG. 7, there is only a single subprocess pod 202 (e.g., subprocess pod 202B for processing subprocess B21) with the same parent process task (e.g., B2) that has not yet been restarted. As a result, subprocess pod 202B is selected to be restarted on the available node 201 (e.g., node 201C).

Furthermore, jobs updater 209 updates the timeout of the selected subprocess pod 202 (e.g., subprocess pod 202B) based on the current and timeout for the parent process as discussed above. For example, as illustrated in FIG. 8, FIG. 8 illustrates updating the timeout of an additional subprocess pod 202 (e.g., subprocess pod 202B) after the completion of a subprocess pod 202 (e.g., subprocess pod 202D) in accordance with an embodiment of the present disclosure.

As shown in FIG. 8, process execution status table 303 includes a column 801 directed to the pod end time, which corresponds to the time (e.g., 00:08:00) that the processing of the assigned tasks by that subprocess pod 202 (e.g., subprocess pod 202D handling subprocess B23) was completed. As shown in FIG. 8, the pod end time for subprocess pod 202D handling subprocess B23 is 00:08:00. As discussed above, in one embodiment, upon completion of executing its assigned tasks, such as subprocess pod 202D, process planner 210 informs scheduler 206 regarding the completion of subprocess pod 202D executing its assigned tasks. In one embodiment, scheduler 206 then instructs the appropriate agent 208 (e.g., agent 208C) to evict such a subprocess pod 202 (e.g., subprocess pod 202D) from node 201 (e.g., node 201C).

Furthermore, as discussed above, process planner 210 selects subprocess pod 202B to be restarted on the available node 201 (e.g., node 201C) to handle subprocess B21. As a result, jobs updater 209 updates the timeout of the selected subprocess pod 202 (e.g., subprocess pod 202B) based on the current and timeout for the parent process as discussed above. For example, as shown in FIG. 8, jobs updater 209 updates the timeout of subprocess pod 202B for handling subprocess B21 by adding to the current time (00: 08:15) the (timeout for the parent process—(upgrade start time—start time for performing the processing of its assigned tasks)). In one embodiment, the timeout for the parent process may be identified from column 309 of task template table 302 of FIG. 3B. In one embodiment, the upgrade start time may be identified from element 315 of FIG. 3A. In one embodiment, the start time for performing the processing of its assigned tasks may be identified from column 312 of process execution status table 303 of FIG. 3C. In one embodiment, job updater 209 obtains such information to compute the updated timeout from the tables discussed above.

For example, if the current time is 00:08:15, the timeout for the parent process for subprocess pod 202B is 6 minutes (see column 309 of task template table 302 of FIG. 3B), the upgrade start time is 00:05:00 (see element 315 of FIG. 3A), and the start time for performing the processing of its assigned tasks is 00:04:00 (see column 312 of process execution status table 303 of FIG. 3C), the updated timeout is 00:13:15 (00:08:15+(6 minutes−(00:05:00−00:04:00))) as shown by element 802 of FIG. 8.

Upon updating the timeout for the selected subprocess pod 202, jobs updater 209 informs jobs service 212 regarding the updated timeout of the selected evicted subprocess pod 202 (e.g., subprocess pod 202B). In one embodiment, jobs service 212 instructs scheduler 206 to proceed with scheduling the selected evicted subprocess pod 202 to run on the available node 201 (e.g., node 201C) and to instruct the selected evicted subprocess pod 202 (e.g., subprocess pod 202B) to start processing its assigned tasks.

In one embodiment, upon completion of the originally selected evicted subprocess pods 202 (e.g., subprocess pods 202C, 202D) that were required to be completed in order to successfully complete the parent process task (e.g., B2), any other evicted subprocess pods 202 (e.g., subprocess pod 202B) currently running on an available node 201 (e.g., node 201C) with the same parent process task may be terminated (“runtime shutdown”). Afterwards, processes A and C handled by evicted process pods 202E, 202F may be scheduled for execution on an available node 201 by scheduler 206.

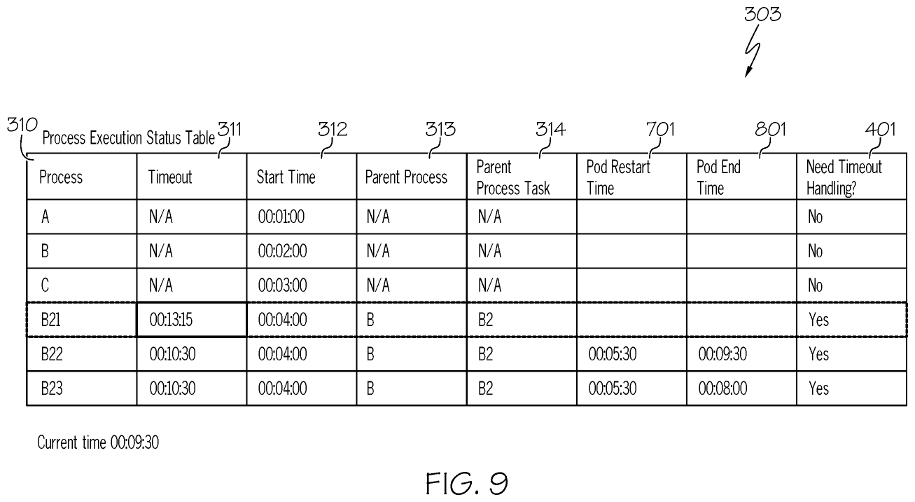

For example, FIG. 9 illustrates the process execution status table (table 303) after completion of the originally selected evicted subprocess pods 202 (e.g., subprocess pods 202C, 202D) that were required to be completed in order to successfully complete the parent process task (e.g., B2) in accordance with an embodiment of the present disclosure.

As shown in FIG. 9, the evicted subprocess pod 202C handling subprocess B22 completed processing its assigned tasks at 00:09:30 (see pod end time in column 801). After the completion of the originally selected evicted subprocess pods 202 (e.g., subprocess pods 202C, 202D) that were required to be completed in order to successfully complete the parent process task (e.g., B2), the evicted subprocess pod 202B handling subprocess B21 is terminated. Such subprocess pods 202 (e.g., subprocess pods 202B, 202C) may then be evicted from node 201 (e.g., node 201C). Processes A and C handled by evicted process pods 202E, 202F may then be scheduled for execution on an available node 201 (e.g., node 201C) by scheduler 206.

A further description of these and other features is provided below in connection with the discussion of the method for handling the eviction of subprocess pods in a serverless workflow.

Prior to the discussion of the method for handling the eviction of subprocess pods in a serverless workflow, a description of an embodiment of a hardware configuration of container orchestration system 102 is provided below in connection with FIG. 10.

Referring now to FIG. 10, in conjunction with FIG. 1, FIG. 10 illustrates an embodiment of the present disclosure of the hardware configuration of container orchestration system 102 which is representative of a hardware environment for practicing the present disclosure.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation, or garbage collection, but this does not render the storage device as transitory because the data is not transitory while it is stored.

Computing environment 1000 contains an example of an environment for the execution of at least some of the computer code involved in performing the inventive methods, such as handling the eviction of subprocess pods in a serverless workflow. In addition to block 1001, computing environment 1000 includes, for example, container orchestration system 102, network 103, such as a wide area network (WAN), end user device (EUD) 1002, remote server 1003, public cloud 1004, and private cloud 1005. In this embodiment, container orchestration system 102 includes processor set 1006 (including processing circuitry 1007 and cache 1008), communication fabric 1009, volatile memory 1010, persistent storage 1011 (including operating system 1012 and block 1001, as identified above), peripheral device set 1013 (including user interface (UI) device set 1014, storage 1015, and Internet of Things (IoT) sensor set 1016), and network module 1017. Remote server 1003 includes remote database 1018. Public cloud 1004 includes gateway 1019, cloud orchestration module 1020, host physical machine set 1021, virtual machine set 1022, and container set 1023.

Container orchestration system 102 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 1018. As is well understood in the art of computer technology, and depending upon the technology, performance of a computer-implemented method may be distributed among multiple computers and/or between multiple locations. On the other hand, in this presentation of computing environment 1000, detailed discussion is focused on a single computer, specifically container orchestration system 102, to keep the presentation as simple as possible. Container orchestration system 102 may be located in a cloud, even though it is not shown in a cloud in FIG. 10. On the other hand, container orchestration system 102 is not required to be in a cloud except to any extent as may be affirmatively indicated.

Processor set 1006 includes one, or more, computer processors of any type now known or to be developed in the future. Processing circuitry 1007 may be distributed over multiple packages, for example, multiple, coordinated integrated circuit chips. Processing circuitry 1007 may implement multiple processor threads and/or multiple processor cores. Cache 1008 is memory that is located in the processor chip package(s) and is typically used for data or code that should be available for rapid access by the threads or cores running on processor set 1006. Cache memories are typically organized into multiple levels depending upon relative proximity to the processing circuitry. Alternatively, some, or all, of the cache for the processor set may be located “off chip.” In some computing environments, processor set 1006 may be designed for working with qubits and performing quantum computing.

Computer readable program instructions are typically loaded onto container orchestration system 102 to cause a series of operational steps to be performed by processor set 1006 of container orchestration system 102 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 1008 and the other storage media discussed below. The program instructions, and associated data, are accessed by processor set 1006 to control and direct performance of the inventive methods. In computing environment 1000, at least some of the instructions for performing the inventive methods may be stored in block 1001 in persistent storage 1011.

Communication fabric 1009 is the signal conduction paths that allow the various components of container orchestration system 102 to communicate with each other. Typically, this fabric is made of switches and electrically conductive paths, such as the switches and electrically conductive paths that make up busses, bridges, physical input/output ports and the like. Other types of signal communication paths may be used, such as fiber optic communication paths and/or wireless communication paths.

Volatile memory 1010 is any type of volatile memory now known or to be developed in the future. Examples include dynamic type random access memory (RAM) or static type RAM. Typically, the volatile memory is characterized by random access, but this is not required unless affirmatively indicated. In container orchestration system 102, the volatile memory 1010 is located in a single package and is internal to container orchestration system 102, but, alternatively or additionally, the volatile memory may be distributed over multiple packages and/or located externally with respect to container orchestration system 102.

Persistent Storage 1011 is any form of non-volatile storage for computers that is now known or to be developed in the future. The non-volatility of this storage means that the stored data is maintained regardless of whether power is being supplied to container orchestration system 102 and/or directly to persistent storage 1011. Persistent storage 1011 may be a read only memory (ROM), but typically at least a portion of the persistent storage allows writing of data, deletion of data and re-writing of data. Some familiar forms of persistent storage include magnetic disks and solid-state storage devices. Operating system 1012 may take several forms, such as various known proprietary operating systems or open-source Portable Operating System Interface type operating systems that employ a kernel. The code included in block 1001 typically includes at least some of the computer code involved in performing the inventive methods.

Peripheral device set 1013 includes the set of peripheral devices of container orchestration system 102. Data communication connections between the peripheral devices and the other components of container orchestration system 102 may be implemented in various ways, such as Bluetooth connections, Near-Field Communication (NFC) connections, connections made by cables (such as universal serial bus (USB) type cables), insertion type connections (for example, secure digital (SD) card), connections made though local area communication networks and even connections made through wide area networks such as the internet. In various embodiments, UI device set 1014 may include components such as a display screen, speaker, microphone, wearable devices (such as goggles and smart watches), keyboard, mouse, printer, touchpad, game controllers, and haptic devices. Storage 1015 is external storage, such as an external hard drive, or insertable storage, such as an SD card. Storage 1015 may be persistent and/or volatile. In some embodiments, storage 1015 may take the form of a quantum computing storage device for storing data in the form of qubits. In embodiments where container orchestration system 102 is required to have a large amount of storage (for example, where container orchestration system 102 locally stores and manages a large database) then this storage may be provided by peripheral storage devices designed for storing very large amounts of data, such as a storage area network (SAN) that is shared by multiple, geographically distributed computers. IoT sensor set 1016 is made up of sensors that can be used in Internet of Things applications. For example, one sensor may be a thermometer and another sensor may be a motion detector.

Network module 1017 is the collection of computer software, hardware, and firmware that allows container orchestration system 102 to communicate with other computers through network 103 (e.g., WAN). Network module 1017 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 1017 are performed on the same physical hardware device. In other embodiments (for example, embodiments that utilize software-defined networking (SDN)), the control functions and the forwarding functions of network module 1017 are performed on physically separate devices, such that the control functions manage several different network hardware devices. Computer readable program instructions for performing the inventive methods can typically be downloaded to container orchestration system 102 from an external computer or external storage device through a network adapter card or network interface included in network module 1017.

In one embodiment, network 103 is any wide area network (for example, the internet) capable of communicating computer data over non-local distances by any technology for communicating computer data, now known or to be developed in the future. In some embodiments, the WAN may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

End user device (EUD) 1002 is any computer system that is used and controlled by an end user (for example, a customer of an enterprise that operates container orchestration system 102), and may take any of the forms discussed above in connection with container orchestration system 102. EUD 1002 typically receives helpful and useful data from the operations of container orchestration system 102. For example, in a hypothetical case where container orchestration system 102 is designed to provide a recommendation to an end user, this recommendation would typically be communicated from network module 1017 of container orchestration system 102 through network 103 (e.g., WAN) to EUD 1002. In this way, EUD 1002 can display, or otherwise present, the recommendation to an end user. In some embodiments, EUD 1002 may be a client device, such as thin client, heavy client, mainframe computer, desktop computer and so on.

Remote server 1003 is any computer system that serves at least some data and/or functionality to container orchestration system 102. Remote server 1003 may be controlled and used by the same entity that operates container orchestration system 102. Remote server 1003 represents the machine(s) that collect and store helpful and useful data for use by other computers, such as container orchestration system 102. For example, in a hypothetical case where container orchestration system 102 is designed and programmed to provide a recommendation based on historical data, then this historical data may be provided to container orchestration system 102 from remote database 1018 of remote server 1003.

Public cloud 1004 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 1004 is performed by the computer hardware and/or software of cloud orchestration module 1020. The computing resources provided by public cloud 1004 are typically implemented by virtual computing environments that run on various computers making up the computers of host physical machine set 1021, which is the universe of physical computers in and/or available to public cloud 1004. The virtual computing environments (VCEs) typically take the form of virtual machines from virtual machine set 1022 and/or containers from container set 1023. It is understood that these VCEs may be stored as images and may be transferred among and between the various physical machine hosts, either as images or after instantiation of the VCE. Cloud orchestration module 1020 manages the transfer and storage of images, deploys new instantiations of VCEs and manages active instantiations of VCE deployments. Gateway 1019 is the collection of computer software, hardware, and firmware that allows public cloud 1004 to communicate through network 103 (e.g., WAN).

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

Private cloud 1005 is similar to public cloud 1004, except that the computing resources are only available for use by a single enterprise. While private cloud 1005 is depicted as being in communication with network 103 (e.g., WAN) in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 1004 and private cloud 1005 are both part of a larger hybrid cloud.

Block 1001 further includes the software components discussed above, such as components 209-211, in connection with FIGS. 2, 3A-3C and 4-9 to handle eviction of subprocess pods in a serverless workflow. In one embodiment, such components may be implemented in hardware. The functions discussed above performed by such components are not generic computer functions. As a result, container orchestration system 102 is a particular machine that is the result of implementing specific, non-generic computer functions.

In one embodiment, the functionality of such software components of container orchestration system 102, including the functionality for handling the eviction of subprocess pods in a serverless workflow may be embodied in an application specific integrated circuit.

As stated above, in container environments, such as a container orchestration system, services may be managed and orchestrated on a cluster using a serverless workflow. The “serverless workflow,” as used herein, refers to an open-source and vendor-neutral specification that enables one to define declarative workflow models that orchestrate event-driven applications. The specification is a project hosted by the Cloud Native Computing Foundation (CNCF). The pods of a node in the container orchestration system utilizing the serverless workflow may each be responsible for executing a process, including executing subprocesses of a process. As discussed above, a pod represents a single instance of a running process (instance of a program) in the cluster. Such a process may be assigned multiple tasks to be completed. Furthermore, such a process (“parent process”) may utilize multiple instances of a subprocess to complete a parent process task of the parent process. A “task,” as used herein, refers to a unit of execution or a unit of work. Each of these subprocess instances though may have an expiration time (“timeout”) to complete the execution of their assigned tasks. In some situations, the parent process task of the parent process is completed only when the majority of the subprocess instances complete execution of their assigned tasks. If a majority of the subprocess instances do not complete their processing of their assigned tasks prior to their expiration time (“timeout”), then the parent process will fail resulting in the failure of the serverless workflow. A pod representing a single instance of a running process in the cluster is referred to herein as a “process pod.” A pod representing a subprocess is referred to herein as a “subprocess pod.” Pods of a node in a container orchestration system utilizing the serverless workflow may be evicted due to resource consumption (e.g., processor, memory) in the node reaching a threshold level thereby freeing up the resource. Furthermore, pods of a node in a container orchestration system utilizing the serverless workflow may also be evicted due to node upgrades. When pods of a node in a container environment utilizing the serverless workflow are evicted, including subprocess pods, such evicted subprocess pods may not be initially selected to run on an available node. By the time such evicted subprocess pods are able to run on a node, such subprocess pods may no longer have time to process its assigned tasks thereby resulting in the failure of the parent process and the serverless workflow.

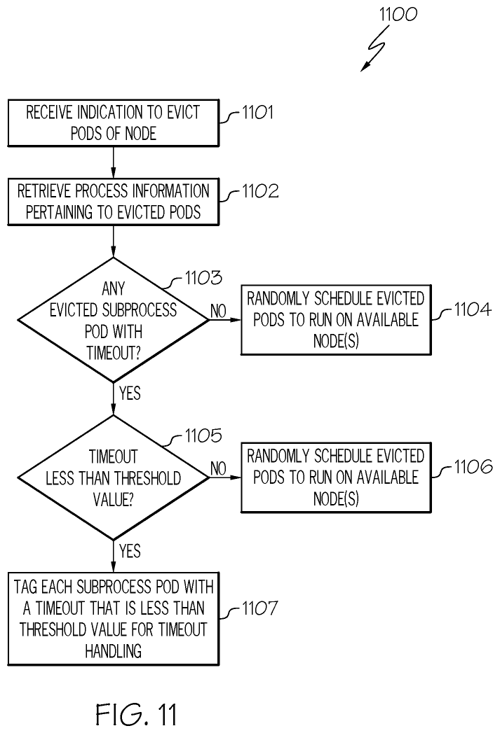

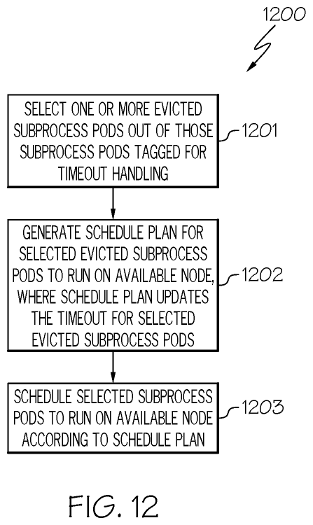

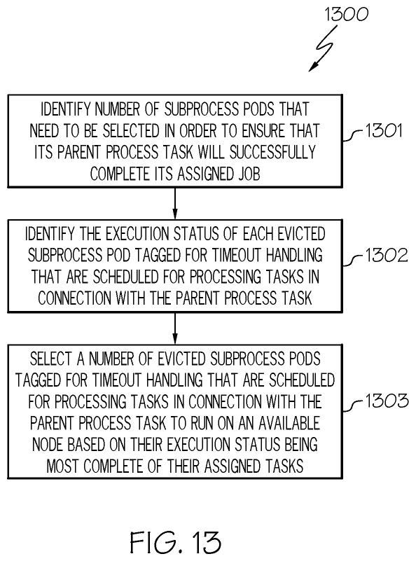

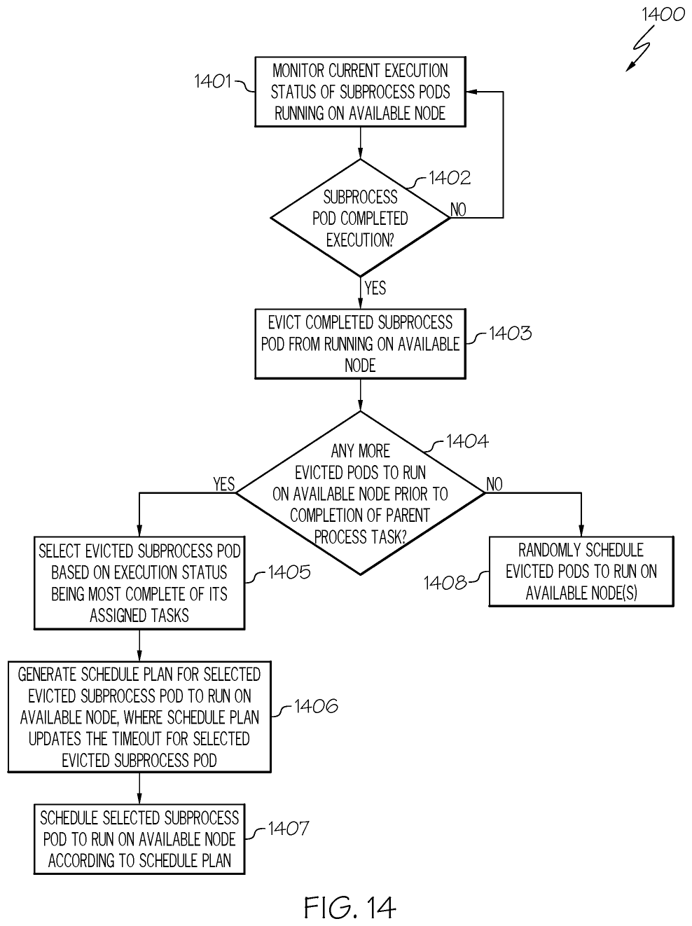

The embodiments of the present disclosure provide a means for preventing the failure of a serverless workflow being utilized in a container environment by updating the timeout of selected evicted subprocess pods in a manner that enables them to complete execution of their assigned tasks prior to their expiration time (timeout) so that their parent process will not fail thereby preventing the failure of the serverless workflow as discussed below in connection with FIGS. 11-14. FIG. 11 is a flowchart of a method for identifying evicted subprocess pods with a timeout that is less than a threshold value. FIG. 12 is a flowchart of a method for handling the eviction of the subprocess pods in a serverless workflow. FIG. 13 is a flowchart of a method for selecting particular evicted subprocess pods to run on an available node. FIG. 14 is a flowchart of a method for handling the scheduling of an additional evicted subprocess pod after the completion of an evicted subprocess pod previously selected to run on an available node.

As stated above, FIG. 11 is a flowchart of a method 1100 for identifying evicted subprocess pods 202 with a timeout that is less than a threshold value in accordance with an embodiment of the present disclosure.

Referring to FIG. 11, in conjunction with FIGS. 1-2, 3A-3C and 4-10, in operation 1101, eviction process filter 211 of container orchestration system 102 receives an indication to evict pods 202 of node 201. In one embodiment, such an indication may be provided to eviction process filter 211 from agent 208, such as in response to receiving an indication to evict pods 202 (e.g., pods 202B-202F) in its associated node (e.g., node 201B) from scheduler 206 which determined to evict such pods 202 in response to resource consumption (e.g., processor, memory) in node 201 (e.g., node 201B) reaching a threshold level or in response to node 201 (e.g., node 201B) being upgraded.

In operation 1102, eviction process filter 211 of container orchestration system 102 retrieves process information pertaining to the evicted pods 202 running on node 201 (e.g., node 201B).

As discussed above, “process information,” as used herein, refers to information pertaining to the serverless workflow being processed by pods 202. An illustration of such process information is provided in connection with FIGS. 3A-3C.

As shown in FIGS. 3A-3C, such process information may be stored in tables, such as table 301 (process template table), table 302 (task template table) and table 303 (process execution status table). In one embodiment, such tables 301, 302, 303 are stored in a storage device (e.g., storage device 1011, 1015) of container orchestration system 102.

In one embodiment, as shown in FIG. 3A, process template table 301 includes a column 304 listing the processes (e.g., process A, B and C) and a column 305 that indicates whether such a process includes a subprocess. As shown in table 301, process B includes a subprocess.

Furthermore, as shown in FIG. 3B, task template table 302 indicates a column 306 designating the task, such as task B2, and a column 307 that indicates its success condition. A “success condition,” as used herein, refers to the percentage of subprocesses that need to complete execution of its assigned tasks prior to having such a task, task B2, complete. As shown in table 302, the success condition for task B2 is >50%. As a result, if task B2 involved three subprocesses, such as subprocess B21 executed on pod 202B, subprocess B22 executed on pod 202C and subprocess B23 executed on pod 202D, then two out of the three subprocesses would need to complete execution of their assigned tasks in order to meet the success condition of greater than 50% (2 out of 3 is greater than 50%).

Furthermore, as shown in FIG. 3B, task template table 302 includes a column 308 regarding the parent process. For example, for task B2, the parent process is process B. Also, as shown in FIG. 3B, task template table 302 includes a column 309 regarding the “timeout.” A “timeout,” as used herein, refers to the time (expiration time) that pod 202 ceases to perform processing of the tasks. In the example of FIG. 3B, the timeout is 6 minutes for each of the subprocess pods 202B-202D used to execute its subprocesses.

Additionally, as shown in FIG. 3C, process execution status table 303 includes a column 310 regarding the process as well as a column 311 indicating whether such a process, including a subprocess, includes a timeout, and if so, the expiration time that pod 202 ceases to perform processing of its assigned tasks.

Furthermore, as shown in FIG. 3C, process execution status table 303 includes a column 312 that indicates the start time for performing the processing of its assigned tasks. For example, the start time for process A pod 202E to begin performing the processing of its assigned tasks is 00:01:00 (hours: minutes: seconds format). The expiration time (see column 311) for performing such processing for process A pod 202E is not applicable (N/A) since it is not a subprocess.

In another example, the start time for process B pod 202A to begin performing the processing of its assigned tasks is 00:02:00 (hours: minutes: seconds format). The expiration time for performing such processing for process B pod 202A is not applicable (N/A) since it is not a subprocess.

In a further example, the start time for process C pod 202F to begin performing the processing of its assigned tasks is 00:03:00 (hours: minutes: seconds format). The expiration time for performing such processing for process C pod 202F is not applicable (N/A) since it is not a subprocess.

In another example, the start time for subprocess B21 pod 202B to begin performing the processing of its assigned tasks is 00:04:00 (hours: minutes: seconds format). The expiration time for performing such processing for subprocess B21 pod 202B is 00:10:00, which corresponds to 6 minutes (timeout for task B2 as shown in column 309 of task template table 302) after the start time.

In a further example, the start time for subprocess B22 pod 202C to begin performing the processing of its assigned tasks is 00:04:00 (hours: minutes: seconds format). The expiration time for performing such processing for subprocess B22 pod 202C is 00:10:00, which corresponds to 6 minutes (timeout for task B2 as shown in column 309 of task template table 302) after the start time.

In another example, the start time for subprocess B23 pod 202D to begin performing the processing of its assigned tasks is 00:04:00 (hours: minutes: seconds format). The expiration time for performing such processing for subprocess B23 pod 202D is 00:10:00, which corresponds to 6 minutes (timeout for task B2 as shown in column 309 of task template table 302) after the start time.

Additionally, as shown in FIG. 3C, process execution status table 303 includes a column 313 directed to the parent process and a column 314 directed to the parent process task. As shown in FIG. 3C, subprocesses B21, B22 and B23 have a parent process of process B and a parent process task of B2. Furthermore, as shown in FIG. 3C, processes A, B and C do not have a parent process or a parent process task (identified as “N/A” for not applicable).

In one embodiment, such information is populated in tables 301, 302 and 303 by scheduler 206 and jobs service 212.

In operation 1103, eviction process filter 211 of container orchestration system 102 determines whether any evicted subprocess pod 202 (e.g., subprocess pods 202B-202D) has a timeout. As shown in FIG. 3C, subprocess pods 202B-202D for handling subprocesses B21, B22 and B23, respectively, have a timeout as shown in column 311 of process execution status table 303.

If eviction process filter 211 could not identify any evicted subprocess pod 202 with a timeout, such as shown in process execution status table 303, then, in operation 1104, scheduler 206 of container orchestration system 102 randomly schedules the evicted pods 202 to run on an available node(s) 201, such as node 201C.

If, however, eviction process filter 211 identifies one or more evicted subprocess pods 202 with a timeout, then, in operation 1105, eviction process filter 211 of container orchestration system 102 determines whether the timeout associated with such evicted subprocess pods 202 is less than a threshold value.

As discussed above, as shown in FIG. 3C, subprocess pods 202B, 202C and 202D have a timeout or expiration time corresponding to 00:10:00. In one embodiment, such a time out is compared with a threshold value. In one embodiment, the threshold value corresponds to the upgrade start time plus the node upgrade average time. For example, as shown in FIG. 3A, the upgrade start time 315 is 00:05:00. If the node upgrade average time is 04:00:00, then the threshold value corresponds to 04:05:00. If the timeout (e.g., 00:10:00) is less than the threshold value (e.g., 04:05:00), then the subprocess pod 202 will not have enough time to complete execution of its assigned tasks. If less than a majority of the subprocess instances of the parent process complete execution of its assigned tasks prior to their expiration time (timeout), then the parent process will fail resulting in the failure of the serverless workflow. As a result, in such situations, eviction process filter 211 tags such a subprocess of the evicted pods (e.g., pods 202B-202D) for timeout handling as discussed below. In one embodiment, the node upgrade average time is obtained from scheduler 206, which keeps track of the average upgrade time for upgrading node 201.

Referring to operation 1105, if the timeout associated with such evicted subprocess pods 202 is not less than the threshold value, then, in operation 1106, scheduler 206 of container orchestration system 102 randomly schedules the evicted pods 202 to run on an available node(s) 201, such as node 201C.

If, however, the timeout associated with such evicted subprocess pods 202 is less than the threshold value, then, in operation 1107, eviction process filter 211 tags such evicted subprocess pods 202 for timeout handling as illustrated in FIG. 4.

For example, as shown in FIG. 4, process execution status table 303 includes a column 401 indicating whether there a need for timeout handling. Such information is provided by eviction process filter 211 as discussed above.

As shown in FIG. 4, subprocesses B21, B22 and B23 of the evicted subprocess pods 202B, 202C and 202D, respectively, need timeout handling. Such an indication is referred to herein as “tagging.”

In response to tagging such subprocess pods 202 for timeout handling, such timeout handling involves identifying the number of subprocess pods that need to be selected in order to ensure that their parent process will successfully complete its assigned job as discussed below in connection with FIGS. 12-13. Furthermore, such timeout handling involves selecting such a number of subprocess pods based on their execution status being most complete of their assigned tasks as discussed below in connection with FIG. 12-13.

FIG. 12 is a flowchart of a method 1200 for handling the eviction of the subprocess pods in a serverless workflow in accordance with an embodiment of the present disclosure.

Referring to FIG. 12, in conjunction with FIGS. 1-2, 3A-3C and 4-11, in operation 1201, process planner 210 of container orchestration system 102 selects one or more evicted subprocess pods 202 out of those subprocess pods (e.g., pods 202B-202D) tagged for timeout handling to be scheduled to run on an available node 201 (e.g., node 201C).

A discussion regarding selecting one or more evicted subprocess pods 202 out of those subprocess pods (e.g., pods 202B-202D) tagged for timeout handling is provided below in connection with FIG. 13.

FIG. 13 is a flowchart of a method 1300 for selecting particular evicted subprocess pods to run on an available node 201 (e.g., node 201C) in accordance with an embodiment of the present disclosure.

Referring to FIG. 13, in conjunction with FIGS. 1-2, 3A-3C and 4-12, in operation 1301, process planner 210 of container orchestration system 102 identifies the number of subprocess pods 202 (e.g., subprocess pods 202B-202D) that need to be selected to run on an available node 201 (e.g., node 201C) in order to ensure that its parent process task (e.g., B2) will successfully complete its assigned job. As previously shown in FIG. 3B, task template table 302 indicates that the success condition for task B2 is greater than 50%. Since there are three subprocesses (subprocess B21, B22 and B23), at least two of these subprocesses need to be selected to complete execution of their tasks in order to ensure that the parent task process B2 is successfully completed by the parent process (process B).

In operation 1302, process planner 210 of container orchestration system 102 identifies the execution status of each evicted subprocess pod 202 (e.g., subprocess pods 202B-202D) tagged for timeout handling that are scheduled for processing tasks in connection with the parent process task (e.g., B2).

In operation 1303, process planner 210 of container orchestration system 102 selects a number of evicted subprocess pods 202 (e.g., subprocess pods 202C, 202D) tagged for timeout handling that are scheduled for processing tasks in connection with the parent process task (e.g., B2) to run on an available node 201 (e.g., node 201C) based on their execution status being most complete of their assigned tasks. In one embodiment, the number of selected evicted subprocess pods 202 corresponds to the number of subprocess pods 202 that need to be selected in order to ensure that its parent process task (e.g., B2) will successfully complete its assigned job.

As discussed above, in one embodiment, in order to determine which evicted subprocess pods 202 that are tagged for timeout handling are to be selected to be run on an available node 201 (e.g., node 201C), process planner 210 identifies the execution status of each evicted subprocess pod 202 (e.g., subprocess pods 202B-202D) tagged for timeout handling as shown in FIG. 5.

Referring to FIG. 5, subprocess B21 is currently processing a service task at time T2. Subprocess B22 is currently processing a task at time T3 and subprocess B23 is currently processing a service task at time T4. Such information as shown in FIG. 5 may be stored in a table, such as shown in FIG. 6.

Referring to FIG. 6, process execution task table 600 includes a column 601 that stores an indication of the subprocess (e.g., subprocess B21, B22 and B23) as well as a column 602 that stores the execution task currently being performed by the corresponding subprocess. For example, for subprocess B21, it is currently processing a service task at time T2 as indicated by “B21_T2” in column 602. In another example, for subprocess B22, it is currently processing a task at time T3 as indicated by “B22 _T3” in column 602. In a further example, for subprocess B23, it is currently processing a service task at time T4 as indicated by “B23 _T4” in column 602.

In one embodiment, such information is populated in table 600 as shown in FIG. 5 by process planner 210 monitoring the current execution status of the assigned tasks by the subprocess pods 202. In one embodiment, process planner 210 monitors the current execution status of the subprocess pods 202 by monitoring the logs, such as the output generated by the subprocess pods 202. In one embodiment, such an output is generated by the containers of the subprocess pod 202, such as using the stdout and stderr data streams. In one embodiment, the output is accessed via the kubectl logs command. In one embodiment, process planner 210 uses various software tools to provide such monitoring, including, but not limited to, Datadog®, Kubelet, cAdvisor, Jaeger, Weave Scope, etc.

In one embodiment, based on the execution status of the evicted subprocess pods 202 tagged for timeout handling, process planner 210 selects the identified number of subprocess pods 202 (e.g., subprocess pods 202C, 202D) that need to be selected to run on an available node 201 (e.g., node 201C) in order to ensure that its parent process task (e.g., B2) will successfully complete its assigned job. For example, as discussed above, in order to ensure that the parent process task of B2 will successfully complete its assigned job, two out of the three subprocesses (B21, B22, B23) need to be selected. In one embodiment, process planner 210 selects those evicted subprocess pods 202 based on the their execution status being most complete of their assigned tasks to run on an available node 201 (e.g., node 201C), where the number of the selected subprocess pods 202 corresponds to the number of subprocess pods 202 that need to be selected to run on an available node 201 (e.g., node 201C) in order to ensure that its parent process task (e.g., B2) will successfully complete its assigned job. As a result, referring to FIGS. 5 and 6, process planner 210 selects subprocess pods 202C and 202D, which are the two subprocess pods that are most complete of their assigned tasks. By selecting subprocess pods that are most complete of their assigned tasks, resource utilization is maximized. That is, by first scheduling subprocess instances with faster progress, resource utilization will be maximized.

Returning to FIG. 12, in conjunction with FIGS. 1-2, 3A-3C, 4-11 and 13, in operation 1202, process planner 210 of container orchestration system 102 generates a schedule plan for the selected evicted subprocess pods 202 (e.g., subprocess pods 202C, 202D) to run on an available node 201 (e.g., node 201C), where the schedule plan updates the timeout for the selected evicted subprocess pods 202 (e.g., subprocess pods 202C, 202D).

As discussed above, the scheduled placement of such evicted subprocess pods 202 (e.g., subprocess pods 202C and 202D) to run on the available node 201 (e.g., node 201C) corresponds to the schedule plan for such evicted subprocess pods 202 (e.g., subprocess pods 202C and 202D). By selecting those subprocess pods 202 (e.g., subprocess pods 202C and 202D) that are most complete of their assigned tasks, the likelihood of ensuring that its parent process task (e.g., B2) will successfully complete its assigned job is improved.

Furthermore, in order to ensure that its parent process task (e.g., B2) will successfully complete its assigned job thereby preventing the failure of the serverless workflow, the timeout for such selected subprocess pods 202 needs to be updated by jobs updater 209. In one embodiment, the schedule plan updates the timeout for the selected evicted subprocess pods 202 (e.g., subprocess pods 202C and 202D) by jobs updater 209. In one embodiment, jobs updater 209 updates the timeout for the selected evicted subprocess pods 202 (e.g., subprocess pods 202C and 202D) based on the current time and timeout for the parent process as discussed further below.

In one embodiment, in the scenario in which the subprocess pods 202 (e.g., subprocess pods 202C and 202D) are evicted due to an update to node 201 (e.g., node 201B), jobs updater 209 updates the timeout for the selected evicted subprocess pods 202 (e.g., subprocess pods 202C and 202D) by adding to the current time the (timeout for the parent process-(upgrade start time-start time for performing the processing of its assigned tasks)). In one embodiment, the timeout for the parent process may be identified from column 309 of task template table 302 of FIG. 3B. In one embodiment, the upgrade start time may be identified from element 315 of FIG. 3A. In one embodiment, the start time for performing the processing of its assigned tasks may be identified from column 312 of process execution status table 303 of FIG. 3C. In one embodiment, jobs updater 209 obtains such information to compute the updated timeout from the tables discussed above.

For example, if the current time is 00:05:30, the timeout for the parent process for subprocess pods 202C, 202D is 6 minutes (see column 309 of task template table 302 of FIG. 3B), the upgrade start time is 00:05:00 (see element 315 of FIG. 3A), and the start time for performing the processing of its assigned tasks is 00:04:00 (see column 312 of process execution status table 303 of FIG. 3C), then the updated timeout is 00:10:30 (00:05:30(6 minutes−(00:05:00−00:04:00))) as shown in FIG. 7.

Referring to FIG. 7, table 303 includes a column 701 for the pod restart time, which corresponds to the time (current time, such as 00:05:30) to restart the processing of the assigned tasks for those particular subprocesses (e.g., B22 and B23) by its subprocess pod 202 (e.g., subprocess pods 202C, 202D). As shown in FIG. 7, the pod restart time for evicted subprocess pods 202C, 202D (for subprocesses B22, B23, respectively) is 00:05:30, which corresponds to the current time, as shown in column 701. Furthermore, as discussed above, the updated timeout corresponds to 00:10:30 as shown by element 702 when the current time is 00:05:30, the timeout for the parent process for subprocess pods 202C, 202D is 6 minutes (see column 309 of task template table 302B of FIG. 3), the upgrade start time is 00:05:00 (see element 315 of FIG. 3A), and the start time for performing the processing of its assigned tasks is 00:04:00 (see column 312 of process execution status table 303 of FIG. 3C). Such an updated timeout is reflected in column 311 of process execution status table 303 as shown in FIG. 7.

After generating the schedule plan for the selected evicted subprocess pods 202 to run on an available node 201, such as node 201C, where the schedule plan updates the timeout for the selected evicted subprocess pods 202 (e.g., subprocess pods 202C, 202D), in operation 1203, scheduler 206 of container orchestration system 102 schedules the selected subprocess pods 202 (e.g., subprocess pods 202C, 202D) to run on an available node 201 (e.g., node 201C) according to the schedule plan. Furthermore, in one embodiment, jobs updater 209 informs jobs service 212 regarding the updated timeout of the selected evicted subprocess pods 202 (e.g., subprocess pods 202C, 202D). In one embodiment, jobs service 212 instructs scheduler 206 to proceed with scheduling the selected evicted subprocess pods 202 to run on the available node 201 (e.g., node 201C) and to instruct the selected evicted subprocess pods 202 (e.g., subprocess pods 202C, 202D) to start processing its assigned tasks at 00:05:30.

After scheduling the selected evicted subprocess pods 202 to run on the available node 201 (e.g., node 201C), additional evicted subprocess pods 202 with the same parent process task may also be selected to run on an available node 201 upon the completion of an evicted subprocess pod 202 previously selected to run on the available node 201 as discussed below in connection with FIG. 14.

FIG. 14 is a flowchart of a method 1400 for handling the scheduling of an additional evicted subprocess pod 202 (e.g., subprocess pod 202B) after the completion of an evicted subprocess pod 202 (e.g., subprocess pod 202D) previously selected to run on an available node 201 (e.g., node 201C) in accordance with an embodiment of the present disclosure.

Referring to FIG. 14, in conjunction with FIGS. 1-2, 3A-3C and 4-13, in operation 1401, process planner 210 of container orchestration system 102 monitors the current execution status of the subprocess pods 202 (e.g., subprocess pods 202C, 202D) running on the available node 201 (e.g., node 201C).

As discussed above, in one embodiment, such monitoring is accomplished by process planner 210 monitoring the logs, such as the output generated by the subprocess pods 202 (e.g., subprocess pods 202C, 202D). In one embodiment, such an output is generated by the containers of the subprocess pod 202, such as using the stdout and stderr data streams. In one embodiment, the output is accessed via the kubectl logs command. In one embodiment, process planner 210 uses various software tools to provide such monitoring, including, but not limited to, Datadog®, Kubelet, cAdvisor, Jaeger, Weave Scope, etc.

In operation 1402, process planner 210 of container orchestration system 102 determines whether a subprocess pod 202 has completed executing its assigned tasks in connection with a parent process task (e.g., B2).

If a subprocess pod 202 has not completed executing its assigned tasks in connection with a parent process task (e.g., B2), then process planner 210 continues to monitor the current execution status of the subprocess pods 202 (e.g., subprocess pods 202C, 202D) running on the available node 201 (e.g., node 201C) in operation 1401.

If, however, one of the subprocess pods 202 (e.g., subprocess pod 202D) has completed executing its assigned tasks in connection with a parent process task (e.g., B2), such as for subprocess B23, then, in operation 1403, agent 208 (e.g., agent 208C) of container orchestration system 102 evicts such a subprocess pod 202D from node 201 (e.g., node 201C).

As discussed above, process planner 210 of container orchestration system 102 informs scheduler 206 regarding the completion of executing its assigned tasks by subprocess pod 202 (e.g., subprocess pod 202D). In one embodiment, scheduler 206 then instructs the appropriate agent 208 (e.g., agent 208C) to evict such a subprocess pod 202D from node 201 (e.g., node 201C).

In operation 1404, process planner 210 of container orchestration system 102 determines whether there are any more subprocess pods 202 with the same parent process task (e.g., B2) to run on the available node 201 (e.g., node 201C) prior to the completion of the parent process task (e.g., B2).

As discussed above, in one embodiment, if there are additional evicted subprocess pods 202 (e.g., subprocess pod 202B) with the same parent process task (e.g., B2) that have not yet been restarted to process its assigned tasks prior to the completion of the parent process task (e.g., B2), then, in operation 1405, process planner 210 selects an evicted subprocess pod 202 (e.g., subprocess pod 202B) out of the evicted subprocess pods 202 with the same parent process task (e.g., B2) that has not yet been restarted based on the execution status being most complete of its assigned tasks. In the scenario illustrated in FIG. 7, there is only a single subprocess pod 202 (e.g., subprocess pod 202B for processing subprocess B21) with the same parent process task (e.g., B2) that has not yet been restarted. As a result, subprocess pod 202B is selected to be restarted on the available node 201 (e.g., node 201C).

In operation 1406, process planner 210 of container orchestration system 102 generates a schedule plan for the selected evicted subprocess pod 202 (e.g., subprocess pod 202B) to run on an available node 201 (e.g., node 201C), where the schedule plan updates the timeout for the selected evicted subprocess pod 202 (e.g., subprocess pod 202B).

As discussed above, the scheduled placement of such an evicted subprocess pod 202 (e.g., subprocess pod 202B) to run on the available node 201 (e.g., node 201C) corresponds to the schedule plan for such an evicted subprocess pod 202 (e.g., subprocess pod 202B). Furthermore, in one embodiment, the schedule plan updates the timeout for the selected evicted subprocess pod 202 (e.g., subprocess pod 202B) by jobs updater 209. In one embodiment, jobs updater 209 updates the timeout for the selected evicted subprocess pod 202 (e.g., subprocess pod 202B) based on the current time and timeout for the parent process as discussed below.

For example, as shown in FIG. 8, process execution status table 303 includes a column 801 directed to the pod end time, which corresponds to the time (e.g., 00:08:00) that the processing of the assigned tasks by that subprocess pod 202 (e.g., subprocess pod 202D handling subprocess B23) was completed. As shown in FIG. 8, the pod end time for subprocess pod 202D handling subprocess B23 is 00:08:00. As discussed above, in one embodiment, upon completion of executing its assigned tasks, such as subprocess pod 202D, process planner 210 informs scheduler 206 regarding subprocess pod 202D completing the execution of its assigned tasks. In one embodiment, scheduler 206 then instructs the appropriate agent 208 (e.g., agent 208C) to evict such a subprocess pod 202 (e.g., subprocess pod 202D) from node 201 (e.g., node 201C).

Furthermore, as discussed above, process planner 210 selects subprocess pod 202B to be restarted on the available node 201 (e.g., node 201C) to handle subprocess B21. As a result, jobs updater 209 updates the timeout of the selected subprocess pod 202 (e.g., subprocess pod 202B) based on the current and timeout for the parent process. For example, as shown in FIG. 8, jobs updater 209 updates the timeout of subprocess pod 202B for handling subprocess B21 by adding to the current time (00:08:15) the (timeout for the parent process—(upgrade start time-start time for performing the processing of its assigned tasks)). In one embodiment, the timeout for the parent process may be identified from column 309 of task template table 302 of FIG. 3B. In one embodiment, the upgrade start time may be identified from element 315 of FIG. 3A. In one embodiment, the start time for performing the processing of its assigned tasks may be identified from column 312 of process execution status table 303 of FIG. 3C. In one embodiment, job updater 209 obtains such information to compute the updated timeout from the tables discussed above.

For example, if the current time is 00:08:15, the timeout for the parent process for subprocess pod 202B is 6 minutes (see column 309 of task template table 302 of FIG. 3B), the upgrade start time is 00:05:00 (see element 315 of FIG. 3A), and the start time for performing the processing of its assigned tasks is 00:04:00 (see column 312 of process execution status table 303 of FIG. 3C), the updated timeout is 00:13:15 (00:08:15+(6 minutes−(00:05:00−00:04:00))) as shown by element 802 of FIG. 8.

In operation 1407, scheduler 206 of container orchestration system 102 schedules the selected subprocess pod 202 (e.g., subprocess pod 202B) to run on the available node 201 (e.g., node 201C) according to the schedule plan. Furthermore, in one embodiment, jobs updater 209 informs jobs service 212 regarding the updated timeout of the selected evicted subprocess pod 202 (e.g., subprocess pod 202B). In one embodiment, jobs service 212 instructs scheduler 206 to proceed with scheduling the selected evicted subprocess pod 202 to run on the available node 201 (e.g., node 201C) and to instruct the selected evicted subprocess pod 202 (e.g., subprocess pod 202B) to start processing its assigned tasks.

In one embodiment, upon completion of the originally selected evicted subprocess pods 202 (e.g., subprocess pods 202C, 202D) that were required to be completed in order to successfully complete the parent process task (e.g., B2), any other evicted subprocess pods 202 (e.g., subprocess pod 202B) currently running on an available node 201 (e.g., node 201C) with the same parent process task may be terminated (“runtime shutdown”). Afterwards, processes A and C handled by evicted process pods 202E, 202F may be scheduled for execution on an available node 201 by scheduler 206.

For example, as shown in FIG. 9, the evicted subprocess pod 202C handling subprocess B22 completed processing its assigned tasks at 00:09:30 (see pod end time in column 801). After the completion of the originally selected evicted subprocess pods 202 (e.g., subprocess pods 202C, 202D) that were required to be completed in order to successfully complete the parent process task (e.g., B2), the evicted subprocess pod 202B handling subprocess B21 is terminated. Such subprocess pods 202 (e.g., subprocess pods 202B, 202C) may then be evicted from node 201 (e.g., node 201C). Processes A and C handled by evicted process pods 202E, 202F may then be scheduled for execution on an available node 201 (e.g., node 201C) by scheduler 206.

Returning to operation 1404, if, however, there are no additional evicted subprocess pods 202 (e.g., subprocess pod 202D) with the same parent process task (e.g., B2) that have not yet been restarted to process its assigned tasks prior to the completion of the parent process task (e.g., B2), then, in operation 1408, scheduler 206 of container orchestration system 102 randomly schedules the remaining evicted pods 202 to run on an available node(s) 201, such as node 201C.

As a result of the foregoing, embodiments of the present disclosure provide a means for preventing the failure of a serverless workflow being utilized in a container environment by updating the timeout of selected evicted subprocess pods in a manner that enables them to complete execution of their assigned tasks prior to their expiration time (timeout) so that their parent process will not fail thereby preventing the failure of the serverless workflow.

Furthermore, the principles of the present disclosure improve the technology or technical field involving serverless workflows for container orchestration systems. As discussed above, in container environments, such as a container orchestration system, services may be managed and orchestrated on a cluster using a serverless workflow. The “serverless workflow,” as used herein, refers to an open-source and vendor-neutral specification that enables one to define declarative workflow models that orchestrate event-driven applications. The specification is a project hosted by the Cloud Native Computing Foundation (CNCF). The pods of a node in the container orchestration system utilizing the serverless workflow may each be responsible for executing a process, including executing subprocesses of a process. As discussed above, a pod represents a single instance of a running process (instance of a program) in the cluster. Such a process may be assigned multiple tasks to be completed. Furthermore, such a process (“parent process”) may utilize multiple instances of a subprocess to complete a parent process task of the parent process. A “task,” as used herein, refers to a unit of execution or a unit of work. Each of these subprocess instances though may have an expiration time (“timeout”) to complete the execution of their assigned tasks. In some situations, the parent process task of the parent process is completed only when the majority of the subprocess instances complete execution of their assigned tasks. If a majority of the subprocess instances do not complete their processing of their assigned tasks prior to their expiration time (“timeout”), then the parent process will fail resulting in the failure of the serverless workflow. A pod representing a single instance of a running process in the cluster is referred to herein as a “process pod.” A pod representing a subprocess is referred to herein as a “subprocess pod.” Pods of a node in a container orchestration system utilizing the serverless workflow may be evicted due to resource consumption (e.g., processor, memory) in the node reaching a threshold level thereby freeing up the resource. Furthermore, pods of a node in a container orchestration system utilizing the serverless workflow may also be evicted due to node upgrades. When pods of a node in a container environment utilizing the serverless workflow are evicted, including subprocess pods, such evicted subprocess pods may not be initially selected to run on an available node. By the time such evicted subprocess pods are able to run on a node, such subprocess pods may no longer have time to process its assigned tasks thereby resulting in the failure of the parent process and the serverless workflow.

Embodiments of the present disclosure improve such technology by receiving an indication to evict pods of a node in a container environment. Such eviction may result due to resource consumption (e.g., processor, memory) in the node reaching a threshold level or due to node upgrades. Upon receiving such an indication, process information pertaining to the evicted pods is retrieved. “Process information,” as used herein, refers to information pertaining to the serverless workflow being processed by the pods. Such process information includes information pertaining to whether a process has a subprocess, the start time for processing tasks, the expiration time (timeout) for processing such tasks, if applicable, the parent process and the parent process task, if applicable, etc. In scenarios in which some of the evicted pods include subprocess pods, based on such processing information, those subprocess pods with a timeout (expiration time for processing their assigned tasks) that is less than a threshold value may be tagged for timeout handling. Such timeout handling involves identifying the number of subprocess pods that need to be selected in order to ensure that their parent process will successfully complete its assigned job. Furthermore, such timeout handling involves selecting such a number of subprocess pods based on their execution status being most complete of their assigned tasks. A schedule plan may then be generated for such selected subprocess pods, where the schedule plan updates the timeout for such subprocess pods to enable them to complete execution of their assigned tasks prior to their expiration time (timeout) even though they were evicted. Such selected subprocess pods may then be scheduled to run on an available node according to the schedule plan. In this manner, by ensuring that such subprocess pods complete execution of their assigned tasks prior to their expiration time (timeout), their parent process will not fail thereby preventing the failure of the serverless workflow. Furthermore, in this manner, there is an improvement in the technical field involving serverless workflows for container orchestration systems.

The technical solution provided by the present disclosure cannot be performed in the human mind or by a human using a pen and paper. That is, the technical solution provided by the present disclosure could not be accomplished in the human mind or by a human using a pen and paper in any reasonable amount of time and with any reasonable expectation of accuracy without the use of a computer.

In one embodiment of the present disclosure, a computer-implemented method for handling an eviction of subprocess pods of a virtualized operating system comprises receiving, by a computing device, an indication to evict pods of a node. The method further comprises retrieving process information pertaining to the evicted pods. The method additionally comprises generating a schedule plan for selected subprocess pods of the evicted pods with a timeout that is less than a threshold value, where the schedule plan updates the timeout for the selected evicted subprocess pods of the evicted pods. Furthermore, the method comprises scheduling the selected subprocess pods to run on an available node according to the schedule plan.

Furthermore, in one embodiment of the present disclosure, the method additionally comprises identifying a number of subprocess pods that need to be selected in order to ensure that a parent process task will successfully complete an assigned job.

Additionally, in one embodiment of the present disclosure, the method further comprises identifying an execution status of each subprocess pod of a plurality of evicted subprocess pods scheduled for processing tasks in connection with the parent process task.

Furthermore, in one embodiment of the present disclosure, the method further additionally comprises selecting a number of subprocess pods of the plurality of evicted subprocess pods based on the execution status of the subprocess pods being most complete of assigned tasks, where the selected number of subprocess pods corresponds to the number of subprocess pods that need to be selected in order to ensure that the parent process task will successfully complete the assigned job.

Additionally, in one embodiment of the present disclosure, the method further comprises updating the timeout for the selected evicted subprocess pods based on a current time and a timeout for a parent process.

Furthermore, in one embodiment of the present disclosure, the method additionally comprises monitoring completion of the selected subprocess pods running on the available node. The method further comprises evicting one of the selected subprocess pods from running on the available node in response to the one of the selected subprocess pods completing execution of its assigned tasks in connection with a parent process task. Furthermore, the method comprises selecting an additional subprocess pod of the evicted pods based on having an execution status being most complete of its assigned tasks in connection with the parent process task. Additionally, the method comprises generating a schedule plan for the selected additional subprocess pod, where the schedule plan for the selected additional subprocess pod updates a timeout for the selected additional subprocess pod based on a current time and a timeout for a parent process. In addition, the method comprises scheduling the selected additional subprocess pod to run on the available node according to the schedule plan.

Additionally, in one embodiment of the present disclosure, the method further comprises tagging each subprocess pod of the evicted pods with a timeout that is less than the threshold value.

Other forms of the embodiments of the computer-implemented method described above are in a system and in a computer program product.

The descriptions of the various embodiments of the present disclosure have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

1. A computer-implemented method for handling an eviction of subprocess pods of a virtualized operating system, the computer-implemented method comprising:
receiving, by a computing device, an indication to evict pods of a node;
retrieving process information pertaining to said evicted pods;
generating a schedule plan for selected subprocess pods of said evicted pods with a timeout that is less than a threshold value, wherein said schedule plan updates said timeout for said selected evicted subprocess pods of said evicted pods; and
scheduling said selected subprocess pods to run on an available node according to said schedule plan.

2. The computer-implemented method as recited in claim 1 further comprising:
identifying a number of subprocess pods that need to be selected in order to ensure that a parent process task will successfully complete an assigned job.

3. The computer-implemented method as recited in claim 2 further comprising:
identifying an execution status of each subprocess pod of a plurality of evicted subprocess pods scheduled for processing tasks in connection with said parent process task.

4. The computer-implemented method as recited in claim 3 further comprising:
selecting a number of subprocess pods of said plurality of evicted subprocess pods based on the execution status of said subprocess pods being most complete of assigned tasks, wherein said selected number of subprocess pods corresponds to said number of subprocess pods that need to be selected in order to ensure that said parent process task will successfully complete said assigned job.

5. The computer-implemented method as recited in claim 4 further comprising:
updating said timeout for said selected evicted subprocess pods based on a current time and a timeout for a parent process.

6. The computer-implemented method as recited in claim 1 further comprising:
monitoring completion of said selected subprocess pods running on said available node;
evicting one of said selected subprocess pods from running on said available node in response to said one of said selected subprocess pods completing execution of assigned tasks in connection with a parent process task;
selecting an additional subprocess pod of said evicted pods based on having an execution status being most complete of assigned tasks in connection with said parent process task;
generating a schedule plan for said selected additional subprocess pod, wherein said schedule plan for said selected additional subprocess pod updates a timeout for said selected additional subprocess pod based on a current time and a timeout for a parent process; and
scheduling said selected additional subprocess pod to run on said available node according to said schedule plan.

7. The computer-implemented method as recited in claim 1 further comprising:
tagging each subprocess pod of said evicted pods with a timeout that is less than said threshold value.

8. A computer program product for handling an eviction of subprocess pods of a virtualized operating system, the computer program product comprising one or more computer readable storage mediums having program code embodied therewith, the program code comprising programming instructions for:
receiving, by a computing device, an indication to evict pods of a node;
retrieving process information pertaining to said evicted pods;
generating a schedule plan for selected subprocess pods of said evicted pods with a timeout that is less than a threshold value, wherein said schedule plan updates said timeout for said selected evicted subprocess pods of said evicted pods; and
scheduling said selected subprocess pods to run on an available node according to said schedule plan.

9. The computer program product as recited in claim 8, wherein the program code further comprises the programming instructions for:
identifying a number of subprocess pods that need to be selected in order to ensure that a parent process task will successfully complete an assigned job.

10. The computer program product as recited in claim 9, wherein the program code further comprises the programming instructions for:
identifying an execution status of each subprocess pod of a plurality of evicted subprocess pods scheduled for processing tasks in connection with said parent process task.

11. The computer program product as recited in claim 10, wherein the program code further comprises the programming instructions for:
selecting a number of subprocess pods of said plurality of evicted subprocess pods based on the execution status of said subprocess pods being most complete of assigned tasks, wherein said selected number of subprocess pods corresponds to said number of subprocess pods that need to be selected in order to ensure that said parent process task will successfully complete said assigned job.

12. The computer program product as recited in claim 11, wherein the program code further comprises the programming instructions for:
updating said timeout for said selected evicted subprocess pods based on a current time and a timeout for a parent process.

13. The computer program product as recited in claim 8, wherein the program code further comprises the programming instructions for:
monitoring completion of said selected subprocess pods running on said available node;
evicting one of said selected subprocess pods from running on said available node in response to said one of said selected subprocess pods completing execution of assigned tasks in connection with a parent process task;
selecting an additional subprocess pod of said evicted pods based on having an execution status being most complete of assigned tasks in connection with said parent process task;
generating a schedule plan for said selected additional subprocess pod, wherein said schedule plan for said selected additional subprocess pod updates a timeout for said selected additional subprocess pod based on a current time and a timeout for a parent process; and
scheduling said selected additional subprocess pod to run on said available node according to said schedule plan.

14. The computer program product as recited in claim 8, wherein the program code further comprises the programming instructions for:
tagging each subprocess pod of said evicted pods with a timeout that is less than said threshold value.

15. A system, comprising:
a memory for storing a computer program for handling an eviction of subprocess pods of a virtualized operating system; and
a processor connected to said memory, wherein said processor is configured to execute program instructions of the computer program comprising:
receiving an indication to evict pods of a node;
retrieving process information pertaining to said evicted pods;
generating a schedule plan for selected subprocess pods of said evicted pods with a timeout that is less than a threshold value, wherein said schedule plan updates said timeout for said selected evicted subprocess pods of said evicted pods; and
scheduling said selected subprocess pods to run on an available node according to said schedule plan.

16. The system as recited in claim 15, wherein the program instructions of the computer program further comprise:
identifying a number of subprocess pods that need to be selected in order to ensure that a parent process task will successfully complete an assigned job.

17. The system as recited in claim 16, wherein the program instructions of the computer program further comprise:
identifying an execution status of each subprocess pod of a plurality of evicted subprocess pods scheduled for processing tasks in connection with said parent process task.

18. The system as recited in claim 17, wherein the program instructions of the computer program further comprise:
selecting a number of subprocess pods of said plurality of evicted subprocess pods based on the execution status of said subprocess pods being most complete of assigned tasks, wherein said selected number of subprocess pods corresponds to said number of subprocess pods that need to be selected in order to ensure that said parent process task will successfully complete said assigned job.

19. The system as recited in claim 18, wherein the program instructions of the computer program further comprise:
updating said timeout for said selected evicted subprocess pods based on a current time and a timeout for a parent process.

20. The system as recited in claim 15, wherein the program instructions of the computer program further comprise:
monitoring completion of said selected subprocess pods running on said available node;
evicting one of said selected subprocess pods from running on said available node in response to said one of said selected subprocess pods completing execution of assigned tasks in connection with a parent process task;
selecting an additional subprocess pod of said evicted pods based on having an execution status being most complete of assigned tasks in connection with said parent process task;
generating a schedule plan for said selected additional subprocess pod, wherein said schedule plan for said selected additional subprocess pod updates a timeout for said selected additional subprocess pod based on a current time and a timeout for a parent process; and
scheduling said selected additional subprocess pod to run on said available node according to said schedule plan.
